(19) United States
(12) Patent Application Publication
(10) Pub. No.: US 2026/0178720 A1
(43) Pub. Date: Jun. 25, 2026

(54) SENSITIVE DATA PROVISION SYSTEM AND METHOD UTILIZING OPTICAL BARCODES, AND RELATED INTERFACES

(71) Applicant: Vircode, Inc., Weston, FL (US)

(72) Inventor: Amit Jindas Shah, Weston, FL (US)

(73) Assignee: Vircode, Inc., Weston, FL (US)

(21) Appl. No.: 19/397,900

(22) Filed: Nov. 22, 2025

Related U.S. Application Data
(60) Provisional application No. 63/709,513, filed on Oct. 20, 2024.

(51) Int. Cl. G06F 21/36; G06F 21/62; G06K 7/14; H04L 9/08

(52) U.S. Cl. CPC G06F 21/36; G06F 21/6245; G06K 7/1417; H04L 9/0825

(57) ABSTRACT

Methods, systems, machine readable media, and related interfaces for delivering sensitive data to a user's computer by use of specific implementations involving optical barcodes such that a first optical barcode is received at a first user computer, the first optical barcode including a first sensitive data. The first sensitive data is decoded at the first user computer using a first decoding information retrieved from a second optical barcode received at the first computer.

### RELATED APPLICATION DATA

This application claims the benefit of priority of U.S. Provisional Patent Application Ser. No. 63/709,513, filed on Oct. 20, 2024, and titled “Sensitive Data Provision System and Method Utilizing Optical Barcodes and Related Interfaces,” which is incorporated by reference herein in its entirety.

### FIELD OF INVENTION

The present invention generally relates to the field of sensitive data transfer between computers. In particular, the present invention is directed to methods, systems, machine readable media, and related interfaces for delivering sensitive data to a user computer.

### SUMMARY OF THE DISCLOSURE

In one implementation, a method of delivering sensitive data to a first user's computer is provided. The method includes receiving a first optical barcode at a first user computer, the first optical barcode having embedded therein a first decoding information; extracting at the first user computer the first decoding information from the first optical barcode; receiving a second matrix bar code at the first user computer, the second optical barcode having a first sensitive data; extracting at the first user computer the first sensitive data from the second optical barcode; decoding the first sensitive data at the first user computer using the first decoding information; determining one or more advertising attributes related to the first sensitive data using only executable programming located locally at the first user computer without transmitting the first sensitive data from the first user computer; transmitting from the first user computer the one or more advertising attributes to a centralized server computer; and receiving at the first user computer from the centralized server computer one or more advertisements based on the one or more advertising attributes.

In another implementation, a method of delivering sensitive data to a first user's computer is provided. The method includes receiving at a first user computer from a first service provider a first optical barcode, the first optical barcode including a first sensitive data; and decoding at the first user computer the first sensitive data using a first decoding information retrieved from a second optical barcode received at the first computer prior to the first optical barcode.

In yet another implementation, a machine readable storage medium including executable instructions for performing a method of delivering sensitive data to a first user's computer is provided. The instructions include a set of instructions for receiving a first optical barcode at a first user computer, the first optical barcode having embedded therein a first decoding information; a set of instructions for extracting at the first user computer the first decoding information from the first optical barcode; a set of instructions for receiving a second matrix bar code at the first user computer, the second optical barcode having a first sensitive data; a set of instructions for extracting at the first user computer the first sensitive data from the second optical barcode; a set of instructions for decoding the first sensitive data at the first user computer using the first decoding information; a set of instructions for determining one or more advertising attributes related to the first sensitive data using only executable programming located locally at the first user computer without transmitting the first sensitive data from the first user computer; a set of instructions for transmitting from the first user computer the one or more advertising attributes to a centralized server computer; and a set of instructions for receiving at the first user computer from the centralized server computer one or more advertisements based on the one or more advertising attributes.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 illustrates one exemplary implementation of a method of delivering or otherwise providing sensitive data to an end user;

FIG. 2 illustrates one exemplary implementation of an embodiment of a method of providing an advertisement to a user computer;

FIG. 3 illustrates one exemplary representation of a system that may be utilized as part of providing one or more advertisements to a user computer;

FIG. 4 illustrates another exemplary implementation of a method of delivering or otherwise providing sensitive data to an end user;

FIG. 5 illustrates one example of an environment of computing devices that can be utilized in a system or method of the current disclosure;

FIG. 6 illustrates one exemplary implementation of a method for managing validation keys for use in a method and/or system of providing data of the current disclosure;

FIG. 7 illustrates another exemplary implementation of a method for managing validation keys for use in a method and/or system of providing data of the current disclosure;

FIG. 8 illustrates one exemplary implementation of a method for creating an optical barcode including decoding information;

FIG. 9 illustrates one exemplary implementation of a method for processing an optical barcode that includes decoding information at a user computer;

FIG. 10 illustrates one exemplary implementation of a method for creating an optical barcode including sensitive data;

FIG. 11 illustrates still another exemplary implementation of a method of delivering or otherwise providing sensitive data to an end user;

FIG. 12 illustrates still another exemplary implementation of a method of delivering or otherwise providing sensitive data to an end user;

FIG. 13 illustrates one example of an environment of computing devices that can be utilized in a system or method of the current disclosure;

FIG. 14 illustrates one example of an implementation of an environment of providing one or more optical barcodes from a data generation computer to a user computer;

FIG. 15 illustrates one example of a diagrammatic representation of an exemplary optical barcode that includes a decoding information;

FIG. 16 illustrates one example of a diagrammatic representation of an exemplary optical barcode that includes a coded sensitive data;

FIG. 17 illustrates one example of a diagrammatic representation of another exemplary optical barcode that includes a decoding information;

FIG. 18 illustrates one example of another diagrammatic representation of an exemplary optical barcode that includes a coded sensitive data;

FIGS. 19A to 19E illustrate various exemplary user interfaces that may be used as part of one or more methods and/or systems of the current disclosure;

FIG. 20 illustrates one example diagrammatic representation of one implementation of a computing device;

FIG. 21 illustrates one example of a portable handheld computing device in the form of a smartphone;

FIG. 22 illustrates a diagrammatic representation of one embodiment of a computing device in the exemplary form of a computer system;

### DETAILED DESCRIPTION

Systems and methods are provided that relate to concepts, systems, platforms, components, subcomponents, features, and/or other various implementations of one or more secure data transfer platforms (“SDT platform”). In one exemplary aspect, an SDT platform of the current disclosure utilizes one or more optical barcodes to provide to an end user information that is coded separately from decoding information necessary for the end user to access the coded information. An SDT platform according to the current disclosure may also determine relevant advertising material for a given element of decoded information and provide such advertising material to the end user (e.g., in conjunction with the decoded information) locally at the end user's computing device without having to disclose the content of the decoded information to the source of the advertising material. Details of the above systems and methods are further discussed herein.

It is noted that data to be provided to an end user via one or more optical barcodes may be sensitive in nature such that an entity providing such data to an end user and/or the end user themselves may want to have a secure way to provide/receive such data. The degree of sensitivity of such data is not necessarily important to the systems and methods of the current disclosure wherein any data or information may be considered sensitive data in that it is provided and/or received by a system or method described herein. In other words, when referring to sensitive data herein, such data may have a sensitivity that may be different depending on the entity determining the sensitivity (and such sensitivity may range from none to extremely high and beyond). Additionally, sensitive data and/or other data provided and/or received via a system and/or method of the current disclosure may include multiple elements of data each having different levels of sensitivity. Examples of a sensitive data include, but are not limited to, a healthcare data or information, a test result data or information, a corporate data or information, a military data or information, and any combinations thereof. In one example, a sensitive data provided and/or received according to a method and/or system of the current disclosure includes a healthcare data and/or information. Several examples will be discussed herein that are in the healthcare context. However, it should be apparent that it is contemplated that such examples could readily apply to other contexts with different types of sensitive data.

In one exemplary embodiment, decoding information that can be used to decode a coded sensitive data is provided to an end user's computer as part of a first optical barcode and the coded sensitive data is provided to the end user's computer as part of one or more additional optical barcodes. Such providing of the first and one or more additional optical barcodes can be done at times that are close to each other and/or at times that are separated by larger amounts of time. For example, in a healthcare context, a patient visiting a healthcare provider may be provided with a first optical barcode having decoding information (the optical barcode being received by the patient's computing device. This may be done, for example, at the beginning of the visit, at the end of the visit, or at another time during the visit. At a different time (e.g., later in the visit, after the visit, etc.) the patient may be provided with one or more additional optical barcodes, each including coded sensitive data (requiring the decoding information to be accessed). Continuing with the healthcare context, an example of such a provided sensitive data may include, but not be limited to, a laboratory test result, a radiological result, a medical imaging result, a diagnostic test result, a medical provider opinion, a medical provider advice, appointment information, other scheduling information, a diagnosis, a recommendation, an HL7/FHIR resource information (e.g., an information from an HL7/FHIR resource category such as those listed at https://www.h17.org/fhir/resourcelist.html, each of which is incorporated herein by reference), other data and/or information, and any combinations thereof. It is noted that the providing and/or receiving of a first optical barcode having decoding information and the providing and/or receiving of one or more additional optical barcodes having coded information may be presented herein such that the providing/receiving of the first optical barcode is described in a sequence or process before the describing of the providing/receiving of the one or more additional optical barcodes. However, it is contemplated and it should be understood that one or all of the one or more additional optical barcodes may be actually provided and/or received at a time that occurs prior to the provision and/or reception of the first optical barcode. The mere appearance or description herein in a process or sequence in a certain order in itself is not intended to require one such provision and/or reception to occur prior to another in time.

Any optical barcode that is capable of containing therein in one instance a particular desired coded sensitive data and in another instance requisite decoding information to access the coded sensitive data may be utilized in one or more exemplary systems and/or methods herein. Examples of an optical barcode include, but are not limited to, a matrix barcode, a GS1 barcode, a UPC barcode, an EAN barcode, a code 128 barcode, a code 39 barcode, a code 93 barcode, a codabar code, an interleaved 2 of 5 code, an MSI/Plessy code, a POSTNET code, an Intelligent Mail Barcode, a QR code, an Aztec code, a Data Matrix code, a PDF417 code (ISO 15438 code), a MaxiCode (ISO/IEC 16023 code), a Han Xin Code (ISO/IEC 20830 code), a Bumpy Barcode, a Voxel Code barcode, an ISO/IEC 16022 barcode, an ISO/IEC 18004 barcode, and ISO/IEC 23941 barcode, a SPARQCode, and any combinations thereof. In one example, an optical barcode is a one-dimensional optical barcode. In another example, an optical barcode is a two-dimensional optical barcode. In yet another example, an optical barcode is a three-dimensional optical barcode. In still another example, an optical barcode is a QR code. An optical barcode may be a matrix barcode. Various formats of matrix barcodes are known (e.g., a QR code such as those under an ISO/IEC 18004 standard or an ISO/IEC 23941 standard; a Data Matrix Code such as those using an ISO/IEC 16022, 15418, 15424, 15434, and/or 15459 standard; etc.). A matrix barcode for use as an optical barcode in a system or method of the current disclosure may be based on any standard now known or later developed. In one example, a matrix barcode for use in a system or method of the current disclosure is a two-dimensional matrix barcode (e.g., a QR code). In another example, a matrix barcode for use in a system or method of the current disclosure is a three-dimensional matrix barcode (e.g., a Bumpy Barcode).

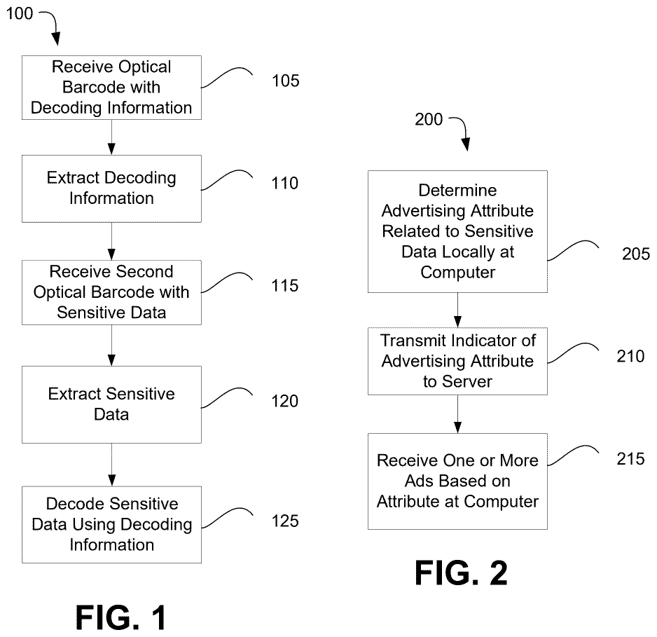

FIG. 1 illustrates one exemplary implementation of a method (100) of delivering or otherwise providing sensitive data to an end user. At step 105 a first optical barcode is received at a user's computing device. The first optical barcode includes decoding information for decoding one or more elements of sensitive data. An optical barcode, such as the first optical barcode in step 105, can be received at a user computer in a variety of ways. Examples of a way to receive an optical barcode at a user computer include, but are not limited to, optically, via an electronic message (e.g., email, SMS text message, proprietary text message, etc.), transfer via a universal serial bus (“USB”) (e.g., over a wired and/or wireless connection to a USB port, via a USB storage device, etc.), via a wireless network connection (e.g., WiFi, WiFi Direct, etc.), via a Bluetooth connection, via a near-field communication connection (e.g., NFC communication, a communication under any one or more of a variety of known standards, including, but not limited to, those established now and in the future by the GSM Association, ISO/IEC (such as ISO/IEC 18092/ECMA-340, ISO/IEC 21481/ECMA-352, etc.), the Store Logistics and Payment with NFC Consortium (StoLPaN), the NFC Forum, or other standards bodies), via a sound wave, and any combinations thereof. In one exemplary aspect, an optical barcode may be provided (e.g., directly, indirectly) by a first entity, such as a person or business, by any of the mechanisms discussed above or other mechanisms now known or later developed (e.g., via direct or indirect provision of an optical barcode from a computer, such as a data generation computer discussed further below) to an end user. For assisting with receiving an optical barcode, a user computer may include an imaging device, such as a camera, for capturing an optical barcode that is provided in a visual/optical mechanism. Examples of a visual/optical mechanism for providing/receiving an optical barcode include, but are not limited to, displaying an optical barcode on a display device (e.g., a display device associated with a computer device of the provider of the optical barcode), displaying an optical barcode in a printed format (e.g., printed on a paper or other material, such as by a computing device of the provider, and provided to a user), and any combinations thereof.

In one exemplary aspect, an optical barcode may be received at a user computer in a known secure environment in order to reduce the likelihood of interception by a third party of the optical barcode or any of the information included therein. In one such example, an optical barcode may be received at a user computer in a visual/optical mechanism in a known secure environment. A known secure environment is an environment in which one or more security measures for reducing a likelihood of interception of an optical barcode as it is provided to an end user is taken (e.g., by a provider of an optical barcode, by an end user, by another, etc.). Examples of a security measure for reducing a likelihood of interception of an optical barcode include, but are not limited to, limiting individuals in a vicinity where an optical barcode is displayed to an end user (e.g., limiting individuals in a room where an optical barcode is displayed to the end user and authorized individuals of the provider of the optical barcode, displaying an optical barcode only when an end user or authorized individuals of a provider of an optical barcode can see or otherwise capture the display, etc.), screening the visibility of a display of an optical barcode to limit viewability (e.g., equipping a display screen device with screens and/or filters that limit viewability, such as peripheral viewability), providing a printed format of an optical barcode with a screening mechanism that limits viewability of the optical barcode (e.g., placing the printed format in an envelope and/or providing a cover, such as a sticker, over the optical barcode that can later be removed by the end user when in a secure location), and any combinations thereof. In one example, in a healthcare context, a patient is provided with a display and/or printed format of an optical barcode during a healthcare visit (e.g., in an examination room) where only the patient (and, optionally, individuals known to the patient, such as family members) and healthcare providers are present such that the patient can optically capture the optical barcode using an imaging device/camera of a patient computing device (e.g., a mobile device).

Returning again to method 100 and FIG. 100, at step 110 decoding information is extracted from the optical barcode received in step 105. Different types of optical barcodes use different processes for extracting information that is embedded in the particular format used by the optical barcode. For the sake of clarity, the current disclosure utilizes the term “extraction” to denote the process of taking information out of the format of an optical barcode. It is recognized that this process may typically utilize the terms encoding for the subprocess of putting information into the format of the optical barcode and decoding for the subprocess of taking information out of the format of the optical barcode (each format of optical barcode having known standards and variations for the encoding and decoding of information from the format). In the current disclosure, the terms coded, decode, and variants thereof when referring to sensitive data that is placed into a format of an optical barcode refers to processes and status of the sensitive data prior to being placed into the format of the optical barcode and after being taken out of the format (i.e., “extracted”) from the format of the optical barcode. For example, a sensitive data may be encrypted prior to being put into the format of an optical barcode and may be decoded (e.g., decrypted) with optional accompanying validation and verification processes (examples of which are discussed further below) after being extracted from an optical barcode. Decoding information (e.g., the decoding information extracted at step 110) is information that is used in decoding (which may optionally include validating and/or verifying processes) or otherwise making available sensitive data after it is extracted from an optical barcode (i.e., and is not the information involved in the process of putting the sensitive data into the format of the optical barcode or taking it out of/extracting it from the format of the optical barcode).

At step 115, a second optical barcode having coded sensitive data included therein is received at the user computer. At step 120, the coded sensitive data is extracted from the second optical barcode. At step 125, the coded sensitive data is decoded using the decoding information from the first optical barcode (see steps 105 and 110). It is noted that steps 115 to 125 may be repeated multiple times such that a plurality of optical barcodes having coded sensitive data included therein may be received, the coded sensitive data extracted from the corresponding optical barcode, and the coded sensitive data decoded using the same decoding information received at step 105. Alternatively and/or in addition to (such that combinations can exist) having multiple optical barcodes that include coded sensitive data be decodable using the same decoding information from a single other optical barcode, multiple optical barcodes having decoded sensitive data therein may require additional other optical barcodes having decoding information therein.

The decoding information included in an optical barcode can be any one or more pieces of information that can be used by a computing device to make a coded sensitive data received via a separate optical barcode accessible (e.g., decrypting an encrypted sensitive data) to a user. Decoding a data element using decoding information from an optical barcode (or otherwise making a data element accessible) may include a technique such as, for example, decrypting an encrypted data element, validating an element of sensitive data (e.g., using a validation key), verifying an element of sensitive data (e.g., using a hashing technique), reviewing and/or verifying a digital signature of a data element, verifying a digital signature of a data key used in any of the foregoing, other data validation and accessibility techniques, and any combinations thereof. Examples of a decoding information include, but are not limited to, an encryption key, a hash key, a symmetric encryption key, an initialization vector for an encryption key, a validation key (e.g., a public validation key, a private validation key), a digital signature of a key (e.g., a digital signature of a public validation key), a public/private encryption key, and any combinations thereof. In one example, a decoding of a coded sensitive data includes only a decryption of encrypted data that has been extracted from an optical barcode. In another example, a decoding of a coded sensitive data includes decryption of encrypted data that has been extracted from an optical barcode and one or more of the following: validating a decrypted sensitive data using a validation key (e.g., a validation public key), verifying a signature of a validation key, and verifying that a sensitive data received at a user computer is authentic (e.g., comparing a hashed version of sensitive data, such as a hashed version of encrypted sensitive data, that is received as part of an optical barcode to the sensitive data received).

Encrypting and decrypting data can be done by any of a variety of well-known techniques. Example techniques for use in encrypting and decrypting data include, but are not limited to, a symmetric key encryption algorithm (e.g., a stream cipher algorithm and/or a block cipher algorithm), a 128-bit cipher (e.g., a 128-bit encryption cipher), a 256-bit cipher (e.g., a 256-bit hash cipher), a HMAC-SHA-256 technique, an elliptical curve (EC) technique, a Rivest-Shamir-Adleman (RSA) public-key cryptography, and any combinations thereof. Encrypting and decrypting data includes the use of one or more encryption keys, as is known to those of ordinary skill.

Verifying that a sensitive data that is received at a user computer is authentic is a process of checking that a received data element is the same data element that was intended to be transferred to the user. In one example, verifying a sensitive data element that is received at a user computer is authentic includes providing a hash key as part of decoding information included in a first optical barcode, applying a hash to the sensitive data using the hash key prior to placing it into an optical barcode format (e.g., applying a hash to an encrypted version of the sensitive data), providing the hashed version of the sensitive data along with the sensitive data to an end user computer as part of a second optical barcode, applying the hash key received in the first optical barcode to the received sensitive data (e.g., to a received encrypted sensitive data) to create a verification hash of the sensitive data, and comparing the received hashed sensitive data to the verification hash to verify that the received sensitive data element is the same as the one provided by the provider of the data (e.g., a healthcare provider in a healthcare context). In one exemplary aspect, such a verification process (i.e., when a received hash of data does not match a verification hash) may provide an indication that a received sensitive data may have been tampered with and/or sent by an inauthentic entity other than the intended provider of data.

Validating a decrypted sensitive data using a validation key is a further process of enhancing security of a data transfer. In one example, a validation public key and a validation private key are generated or otherwise obtained (e.g., at a data generation computer as discussed further below), the validation public key is included as part of decoding information provided in a first optical barcode to a user computer, and the validation public key is used to validate a sensitive data at the user computer after the sensitive data is decoded from the format of a second optical barcode received at the user computer. In one such example, the validation private key is used (e.g., at the data generation computer) prior to including a sensitive data in a format of the second optical barcode (e.g., in an unencrypted form, prior to encryption) to digitally sign the sensitive data, the signature of the sensitive data (e.g., a signature of unencrypted sensitive data) is included with coded sensitive data in the second optical barcode provided to the user computer, and the signature of the sensitive data and validation public key received as part of decoding information in the first optical barcode (along with the sensitive data in unencrypted form if signed in unencrypted form and in encrypted form if signed in encrypted form) are used together to verify the sensitive data received is the same as that intended by a provider to be provided to a user. Based on the public key used (e.g., EC, RSA, etc.) a specific mechanism is known to verify the data (e.g., based on the signature, public key, and data (or the data's hash)). Example mechanisms include, but are not limited to, an elliptical curve digital algorithm technique, an RSA technique, and any combinations thereof.

Verifying a signature of a validation public key are each processes to enhance the security of the provision and decoding of a sensitive data including a check to determine if a signature is still valid (e.g., that it the signature originally created, that it is not out of date or otherwise expired, that it has not been corrupted, etc.). In one example, a validation public key (e.g., generated at a data generation computer) is digitally signed (e.g., by being sent to a signing computer and being signed using a private signing key) prior to being included in decoding information provided in an optical barcode, the signature of the validation public key and the validation public key are provided in decoding information as part of a first optical barcode provided to a user computer, and after being extracted from a format of the first optical barcode the signature of the validation public key is transmitted (e.g., from the user computer) to a signing computer to be verified. In one such example, a signature of a validation public key (e.g., after being received as part of a decoding information in an optical barcode, after a corresponding validation public key is used to verify sensitive data, etc.) is transmitted or otherwise provided to a signing computer and the signing computer utilizes a signing/root key (i.e., a key that corresponds to the key used to originally sign the validation public key) to verify that the validation public key is still valid. In another such example, a signature of a validation public key (e.g., after being received as part of a decoding information in an optical barcode, after a corresponding validation public key is used to verify sensitive data, etc.) is verified locally (e.g., at a user computer) by using the received public validation key, the signature of the public validation key, and a root/signing public key that corresponds to the key originally used to sign the validation public key (e.g., by using an elliptical curved digital algorithm). A root/signing public key can be obtained at a user computer for verifying a signature of a public validation key (e.g., by the user computer requesting from a signing computer that the root/signing public key be provided to the user computer such as at the time of use, by the root/signing public key being included in an application running on the user computer (and optionally updated from time to time), etc.). It is noted that a signing computer may be a separate computer (e.g., operated by a digital signing third party entity), but may also be part of a data generation computer that provides one or more optical barcodes and related information/data.

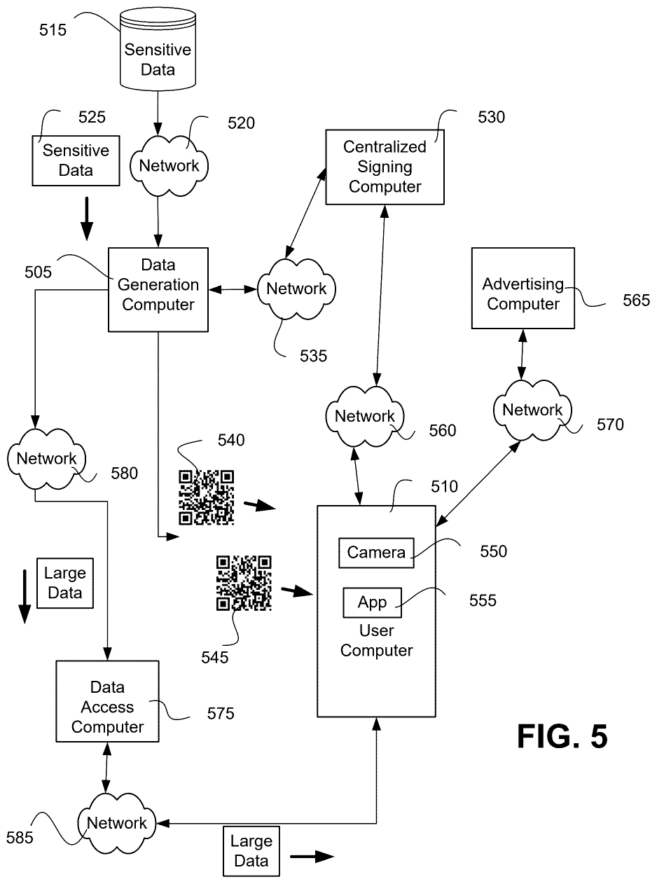

It is contemplated that some sensitive data may be too large to include in an optical barcode. For example, certain radiological or imaging results (e.g., in a healthcare context) or other images and large data file formats may be too large to include in an optical barcode. Sensitive data may be provided to a user computer (e.g., as in step 105) by including a link to a location that is accessible to the user computer (e.g., a data access computer on a network that is accessible to the user computer). In one exemplary aspect a provision of a link to such a location may be provided within an optical barcode provided to be received by a user computer in place of or in addition to one or more elements of sensitive data actually included in the optical barcode (as in step 115). In such a case, the location of the sensitive data may be the same data generation computer that provides the optical barcode and/or a dedicated data access computer (e.g., data access computer 575 discussed further below with respect to FIG. 5) that is separate from the data generation computer. Additional sensitive data that is accessible via a link provided in an optical barcode may be coded similarly to that of sensitive data included within an optical barcode itself (e.g., as in step *15) such that it can be decoded using decoding information that is sent in a separate optical barcode (e.g., as in step 125). Examples of a link to a location having large or otherwise additional sensitive data include, but are not limited to, a network hyperlink, a universal resource locator (URL), a link to register for push notifications of the existence of additional sensitive data to download to a user computer, a link to register for push transfer of additional sensitive data, and any combinations thereof. In one example, a link to a location of additional sensitive data for a user computer that is included in an optical barcode includes a link to a data access computer that registers the user computer to receive push notifications that additional sensitive data is available. In one such example, the user computer can then receive the additional sensitive data (e.g., from the corresponding data access computer) at the user computer (e.g., via application programming thereon requesting the data, such as by being initiated by a user input to the application programming and/or by automatic initiation by the application programming). Once the additional sensitive data is located at the user computer, if it is coded, it may be decoded with decoding information acquired by the user computer via a separate optical barcode (which may be the same or different optical barcode and corresponding decoding information used to decode an element of sensitive data sent to the user computer embedded in an optical barcode). In another example, a link to a location of additional sensitive data for a user computer that is included in an optical barcode includes a link to a data access computer that registers the user computer to receive push when relevant additional sensitive data is available to be downloaded. In one such example, the user computer can then receive automatic downloading of the additional sensitive data (e.g., from the corresponding data access computer) at the user computer. Once the additional sensitive data is located at the user computer, if it is coded, it may be decoded with decoding information acquired by the user computer via a separate optical barcode (which may be the same or different optical barcode and corresponding decoding information used to decode an element of sensitive data sent to the user computer embedded in an optical barcode).

FIG. 2 illustrates one exemplary implementation of an embodiment of a method 200 of providing an advertisement to a user computer. At step 205, one or more advertising attributes that are related to a sensitive data (e.g., a sensitive data received via one or more optical barcodes, such as method 100 of FIG. 1, a sensitive data received otherwise described herein, etc.) are determined at a user computer. Sensitive data may reside on a user computer to be used relative to step 205 from one or more of a variety of ways including for example, but not limited to, being received by a user computer as part of one or more optical barcodes (such as described with respect to method 100 above and elsewhere herein), being received by a user computer via a direct connection with a data source (e.g., via a direct communication over a network between a user computer and a data store having the sensitive data, such as by connecting a user computer directly (e.g., via fast healthcare interoperability resource (FHIR) protocol, via Digi Locker protocol, via another protocol) with an electronic health record (EHR), electronic medical record (EMR), or other healthcare storage/processing/data lake/application/or the like information system). In one exemplary aspect, the one or more advertising attributes are determined without a requirement for disclosing the sensitive data itself to a device other than the user computer. Such a determination may be conducted locally at the user computer using application software designed and configured to review all or a portion of a set of sensitive data to determine the one or more advertising attributes related to the sensitive data. Examples of techniques for making such a determination using such application software include, but are not limited to, comparing all or a portion of one or more sensitive data elements located at the user computer to one or more categories of data stored at the user computer to determine a category related to the sensitive data, identification of one or more keywords in all or a portion of one or more sensitive data elements (e.g., using keyword information stored locally at the user computer), identification of one or more numerical criteria (e.g., a data value exceeding a threshold, a data value below a threshold, and any combinations thereof), identification of one or more qualitative criteria, identification of an indication in all or a portion of one or more sensitive data elements of an identifiable condition indicated (e.g., expressly and/or implicitly via analysis of data) in the sensitive data, comparison of all or a portion of one or more sensitive data elements to a table of known information, identification of an abnormal value in all or a portion of one or more sensitive data elements, implementation of an algorithm that reviews all or a portion of one or more sensitive data elements, implementation of an artificial intelligence functionality against all or a portion of one or more sensitive data elements (e.g., and comparison to information associated with the artificial intelligence functionality), and any combinations thereof. An advertising attribute is information (such as a category of advertising type, thematic information related to certain data, a general condition indicated by data) that can be used to provide an advertisement relevant to the sensitive data at the user computer (e.g., without conveying sensitive data itself).

In one example in a healthcare context, programming of a user computer may review all or a portion of one or more sensitive data elements (e.g., diagnostic test results) at the user computer and determine the existence of a data value indicating a HbA1c or blood glucose level that exceeds a known threshold to determine an advertising attribute that is a category of “pre-diabetes related advertisements.” In another example, programming of a user computer may review all or a portion of one or more sensitive data elements at the user computer and apply the following algorithm: (a) must identify a diabetes type 2 condition, (b) must identify a high HbA1c lab value, (c) must identify a creatine clearance level: >45 mL/min/1.73 m², (d) must identify an eGFR value of >30 mL/min/1.73 m², (e) must not find or identify an ASCVD (atherosclerotic cardiovascular disease) condition. In such an example, the programming may determine an advertising attribute that is a category of “GLP-1 Inhibitor without ASCVD.” In yet another example, programming of a user computer may review all or a portion of one or more sensitive data elements at the user computer and apply the following algorithm: (a) must identify a diabetes type 2 condition, (b) must identify a high HbA1c lab value, (c) must identify a creatine clearance level: >45 mL/min/1.73 m², (d) must identify an eGFR value of >30 mL/min/1.73 m², (e) must identify an ASCVD (atherosclerotic cardiovascular disease) condition. In such an example, the programming may determine an advertising attribute that is a category of “GLP-1 Inhibitor with ASCVD.”

At step 210, one or more indicators of the one or more advertising attributes that are determined at step 205 is communicated from the user computer to an advertising computer (e.g., a centrally located advertising server). The advertising computer utilizes the one or more indicators to identify one or more advertisements related to the one or more advertising attributes. At step 210, the actual sensitive data that was referred to on the user computer to determine the one or more advertising attributes is not communicated to the advertising computer with the one or more indicators. Additionally, the real-world identity (e.g., email address, account name, real name, physical address, visit dates, lab dates, or other personal information) of the user of the user computer may be omitted from the communication from the user computer to the advertising computer (e.g., to enhance privacy and/or security). In such an example, an anonymous or pseudonymous mechanism may be utilized to route the one or more advertisements back to the user computer. Examples of an anonymous our pseudonymous mechanism for routing one or more advertisements include, but are not limited to, an anonymous or pseudonymous identifier (e.g., routing number, reply identifier, IP address of user computer, machine identifier for a user computer, push identifier, advertising identifier, etc.) included with the communication of the one or more indicators to the advertising computer, an open communication session between the user computer and the advertising computer (e.g., an open API session, etc.), a formatting of the communication of the one or more indicators to the advertising computer as a universal resource locator (URL) call over a network, and any combinations thereof. An indicator of one or more advertising attributes can take any of a variety of forms that convey to an advertising computer enough information to return to the corresponding user computer one or more advertisements based on the one or more advertising attributes. Examples of such forms include, but are not limited to, an express statement of an advertising attribute, an abbreviation of an advertising attribute, a keyword or phrase that can be correlated by an advertising computer to an advertising attribute (e.g., via a crossover table at the advertising computer), an International Classification of Diseases Ninth Revision Code (ICD-9 code), an International Classification of Diseases Tenth Revision Code (ICD-10 code), an International Classification of Diseases Ninth Revision Clinical Modification Code (ICD-9-CM code), an International Classification of Diseases Tenth Revision Clinical Modification Code (ICD-10-CM code), a Systematized Nomenclature of Medicine (SNOMED) code, a Logical Observation Identfiers Names and Codes (LOINC) code, and any combinations thereof.

Referring to the example from step 205 in which the determined category was “GLP-1 Inhibitor without ASCVD” an indicator of the category could be in the form of an abbreviation “GLP-1+NOASVD,” which can be communicated via a URL request from the user computer (e.g., in the form of https://genericURL.com/image?campaign=GLP-1+NOASCVD, wherein the “image?campaign=” portion of the URL identifies an instruction to the advertising computer located at genericURL.com to return one or more advertisements related to the communicated category). In the example from step 205 above in which the determined category was “GLP-1 Inhibitor with ASCVD” an indicator of the category could be in the form of an abbreviation “GLP-1+ASVD,” which can be communicated via a URL request from the user computer (e.g., in the form of https://genericURL.com/image?campaign-GLP-1+ASCVD, wherein the “image?campaign=” portion of the URL identifies an instruction to the advertising computer located at genericURL.com to return one or more advertisements related to the communicated category).

At step 215, one or more advertisements based on the one or more advertising attributes is received at the user computer from the advertising computer. One or more advertisements may be stored in a memory of a user computer. In another example, an advertisement received at a user computer may be streamed to a user of the user computer (e.g., without storage of the advertisement in a memory of the user computer aside from any storage necessary incidentally to the streaming of the advertisement).

After receiving one or more advertisements, one or more advertisements may be displayed or otherwise provided to a user of a user computer in a variety of ways. Example ways of displaying or otherwise providing an advertisement include, but are not limited to, displaying an advertisement in line with sensitive data to which it relates (e.g., sensitive data used to determine the corresponding one or more advertising attributes the relate to the displayed advertisement), displaying an advertisement in line with sensitive data to which it does not relate, displaying an advertisement on the same display screen as an element of sensitive data, displaying an advertisement on a different display screen as an element of sensitive data, displaying an advertisement as in a pop up window, displaying a plurality of advertisements included in a set of one or more advertisements in series, displaying a plurality of advertisements included in a set of one or more advertisements at different times that are spaced apart, providing an audio component of an advertisement via a speaker or other audio device associated with a user computer, and any combinations thereof.

An advertisement may take any of a variety of forms. Example forms for an advertisement include, but are not limited to, a still image, a video, a still image with audio, a video with audio, an audio form, a text form, a haptic form (e.g., for use with a computing device having a haptic feedback device associated therewith, such as a device for enhancing experience or a device for use in enhancing accessibility), and any combinations thereof.

Application programming on a user computer may be configured to identify a plurality of relevant advertising attributes, such as identifying multiple categories related to sensitive data on a user computer (e.g., via identification of various conditions, identification of data that exceeds a threshold, data that is below a threshold, identification of an abnormal data value, etc. (e.g., multiple categories, etc.). In one example, indicators of multiple relevant advertising categories are communicated to an advertising computer, one or more relevant advertisements for each advertising category are identified, a subset of the identified advertisements is selected for returning to the corresponding user computer (e.g., based on overall advertising campaign criteria stored at the advertising computer), and that subset of advertisements is provided to be received by the corresponding user computer. In one such example in a healthcare context, programming at a user computer reviews all or a portion of one or more sensitive data elements at the user computer to determine a set of categories based on identified medical conditions (e.g., categorized by one or more ICD-9, ICD-10, ICD-9-CM, ICD-10-CM, SNOMED, etc. codes) and/or a set of categories based on identified observations (e.g., categorized by one or more LOINC, SNOMED, etc. codes), an array of indicators for the determined categories is communicated to an advertising computer (e.g., via a URL request, such as https://genericURL.com/image?condition=[Array of ICD-9, ICD-10, SNOMED, etc. codes] &observation=[Array of LOINC, SNOMED, etc codes], wherein the “image?campaign=” portion of the URL identifies an instruction to the advertising computer located at genericURL.com to return one or more advertisements related to the communicated category), one or more relevant advertisements for each advertising category are identified, a subset of the identified advertisements is selected for returning to the corresponding user computer (e.g., based on overall advertising campaign criteria stored at the advertising computer), and that subset of advertisements is provided to be received by the corresponding user computer.

In another example, indicators of multiple relevant advertising categories are communicated to an advertising computer, one or more relevant advertisements for each advertising category are identified, all of the identified advertisements (or a list of available identified advertisements) is provided to be received by the corresponding user computer, the user computer then selects (e.g., via user intervention, via programmatic application decision-making, based on interest of a user, based on overall advertisement campaign criteria stored at the user computer, and any combinations thereof) a subset of one or more of the identified advertisements (and if not already provided requests from the provided list such subset be communicated from the advertising computer to the user computer). In one such example in a healthcare context, programming at a user computer reviews all or a portion of one or more sensitive data elements at the user computer to determine a set of categories based on identified medical conditions (e.g., categorized by one or more ICD-9, ICD-10, ICD-9-CM, ICD-10-CM, SNOMED, etc. codes) and/or a set of categories based on identified observations (e.g., categorized by one or more LOINC, SNOMED, etc. codes), an array of indicators for the determined categories is communicated to an advertising computer (e.g., via a URL request, such as https://genericURL.com/image?condition=[Array of ICD-9, ICD-10, SNOMED, etc. codes] &observation=[Array of LOINC, SNOMED, etc codes], wherein the “image?campaign=” portion of the URL identifies an instruction to the advertising computer located at genericURL.com to return one or more advertisements related to the communicated category), one or more relevant advertisements for each advertising category are identified, all of the identified advertisements (or a list of available identified advertisements) is provided to be received by the corresponding user computer, the user computer then selects (e.g., via user intervention, via programmatic application decision-making, based on interest of a user, based on overall advertisement campaign criteria stored at the user computer, and any combinations thereof) a subset of one or more of the identified advertisements (and if not already provided requests from the provided list such subset be communicated from the advertising computer to the user computer).

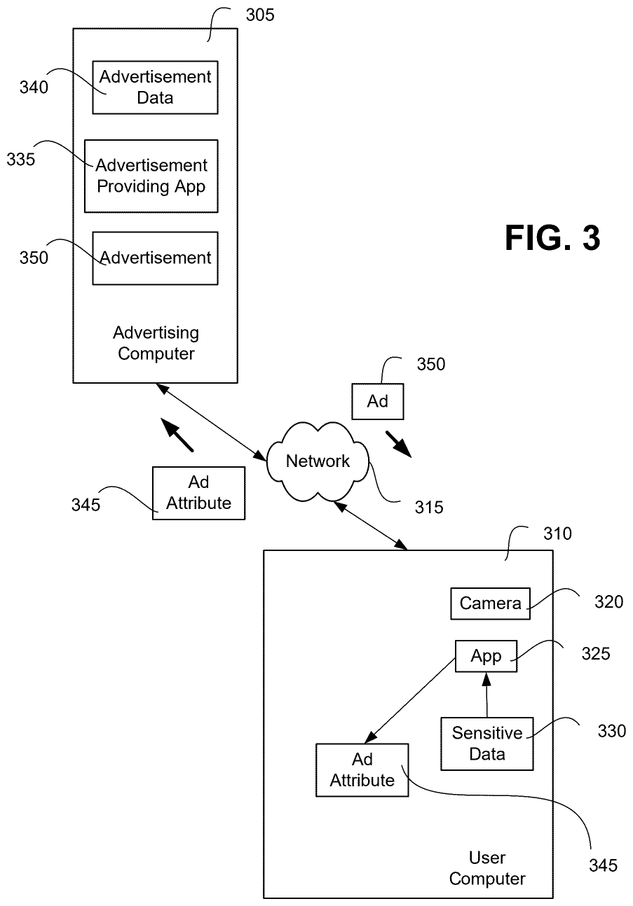

FIG. 3 illustrates one exemplary representation of a system 300 that may be utilized as part of providing (e.g., as set forth with respect to FIG. 2 and other disclosures herein) one or more advertisements to a user computer (e.g., as part of an SDT platform of the current disclosure). FIG. 3 illustrates an advertising computer 305 and a user computer 310, such as a user computer that can be utilized as part of the systems and methods described herein. User computer 310 is shown in communicative connection with advertising computer 305 via a network 315. A user computer, such as user computer 310 or other user computers discussed herein may be any computing device. Network 315 may be any network. Examples of computing devices (and associated components) and networks are discussed further below. User computer 310 is shown having a camera device 320 (e.g., which can be utilized in a receiving of an optical barcode as in certain embodiments disclosed herein), an application programming 325 (e.g., in the form of executable instructions, such as a software application or “app”) for performing functionality related to one or more of the implementations of methods and systems disclosed herein that are performed at a user computer, and one or more elements of sensitive data 330 (e.g., stored in a memory of user computer 310). In a method or system of providing one or more advertisements (e.g., method 200, method 400, method 1200, otherwise as disclosed herein, etc.), application programming 325 may determine one or more advertising attributes 345 that are related to all or a portion of one or more elements of sensitive data 330. One or more advertising attributes 345 can be communicated via network 315 or otherwise to advertising computer 305. Advertising computer 305 includes advertisement providing application programming 335 (e.g., in the form of executable instructions, such as a software application or “app”) and advertisement data 340 that includes one or more advertisements (e.g., stored in a memory of advertising computer 305 or otherwise accessible to advertising computer 305). Application programming 335 is configured to receive the one or more advertising attributes 345, determine one or more relevant advertisements 350 from advertisement data 340, and return one or more advertisements 350 to be received by user computer 310 (e.g., via network 315).

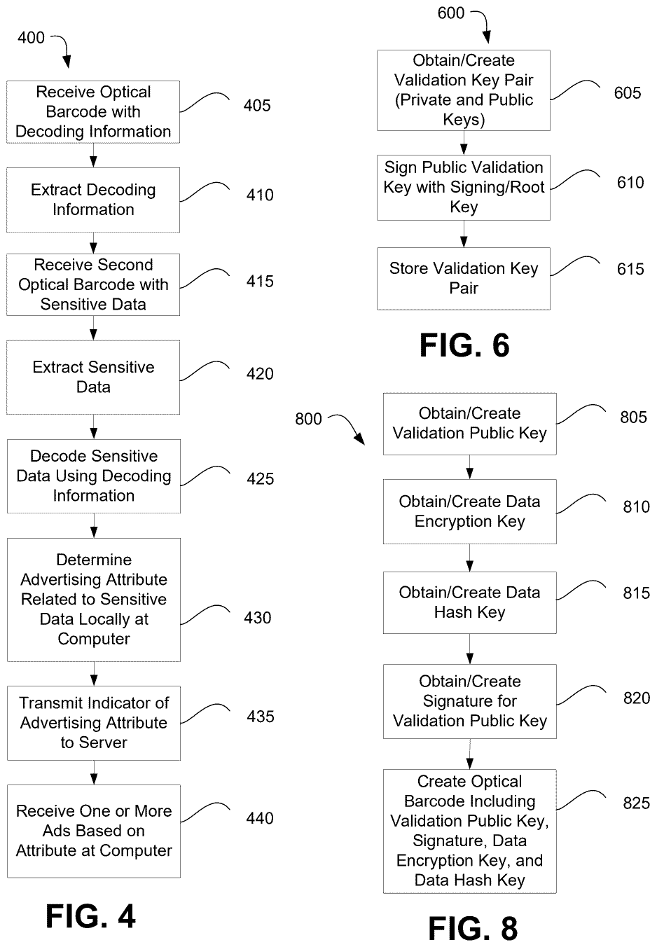

FIG. 4 illustrates another exemplary implementation of a method 400 of delivering or otherwise providing sensitive data to an end user. For the sake of brevity, some of the details, concepts, aspects, features, characteristics, examples, and/or alternatives discussed with respect to the discussion of method 100 of FIG. 1 (and related steps), method 200 of FIG. 2 (and related steps) and other implementations in this disclosure are not repeated in the discussion of FIG. 4. Any one or more of the like details, concepts, aspects, features, characteristics, examples, and alternatives from the discussion with respect to method 100, FIG. 2 (and related steps), and other implementations may apply similarly here where appropriate, except where noted, as if they were explicitly repeated here.

At step 405, a first optical barcode including decoding information is received at a user computer (e.g., from a data generation computer). At step 410, the decoding information is extracted from the first optical barcode at the user computer (e.g., and stored in a memory of the user computer). At step 415, a second optical barcode including coded sensitive data is received at the user computer. At step 420, the coded sensitive data is extracted from the second optical barcode. At step 425, the sensitive data is decoded using the decoding information received with the first optical barcode. At step 430, one or more advertising attributes relevant to all or a portion of the sensitive data is determined at the user computer. At step 435 one or more indicators of the one or more advertising attributes that are determined at step 430 is communicated from the user computer to an advertising computer (e.g., a centrally located advertising server). At step 440, one or more advertisements based on the one or more advertising attributes is received at the user computer from the advertising computer. After receiving one or more advertisements, one or more advertisements may be displayed or otherwise provided to a user of a user computer in a variety of ways.

FIG. 5 illustrates one example of an environment of computing devices that can be utilized in a system or method of the current disclosure (e.g., in relation to method 100, 200, 400, 600, 800, 700, 900, 1000, 1100, 1200). For the sake of brevity, some of the details, concepts, aspects, features, characteristics, examples, and/or alternatives discussed with respect to the discussion of other implementations in this disclosure are not repeated in the discussion of FIG. 5. Any one or more of the like details, concepts, aspects, features, characteristics, examples, and alternatives from the same may apply similarly here where appropriate, except where noted, as if they were explicitly repeated here.

FIG. 5 includes a data generation computer 505 and a user computer 510. In some examples of methods herein, a data generation computer may access sensitive data from a remote data storage (e.g., from a different computing device or platform, such as in a healthcare environment a data generation computer may access sensitive health information (e.g., via fast healthcare interoperability resource (FHIR) protocol, via Digi Locker protocol, via another protocol) from an electronic health record (EHR)/electronic medical record (EMR) system). Such access of sensitive data may be in addition to or in place of sensitive data stored at the data generation computer. Data generation computer 505 is connected to a sensitive data store 515 via a network 520. Data generation computer 505 may access one or more elements of sensitive data 525 (e.g., to include in one or more optical barcodes) from data store 515 via network 520. Data generation computer 505 is also shown in communication with a signing computer 530 via a network 535. Multiple aspects of a signing computer are discussed further above. For example, a data generation computer, such as data generation computer 505, may generate a public validation key and communicate that public validation key to a signing computer, such as signing computer 530, for digital signing (e.g., with a private signing key at the signing computer) with the signing computer returning the digital signature of the public validation key to the data generation computer. Additionally, a signing computer may transmit one or more keys (e.g., a public signing key) to a data generation computer (e.g., for use in verifying a signature, for communication to a user computer, etc.).

Data generation computer 505 is shown providing a first optical barcode 540 that includes decoding information and a one or more additional optical barcodes 545 that each includes sensitive data (and/or a link to a location of additional sensitive data) to user computer 510. Various mechanisms for providing an optical barcode are discussed above and elsewhere herein. User computer 510 includes a camera/image capture device 550 for optically receiving one or more optical barcodes, such as optical barcodes 540, 545. User computer 510 may also or alternatively include other functionality (e.g., a network interface, a wireless functionality, a microphone, etc.) for otherwise receiving an optical barcode from data generation computer 505 (e.g., via a network transfer, via an electronic message, via an audio transfer, etc.). User computer 510 also includes application programming 555 (e.g., in the form of executable instructions, such as an application program or “app”) that is configured to perform one or more of the concepts, aspects, features, characteristics of method 100, 200, 400, 600, 800, 700, 900, 1000, 1100, and/or 1200, and/or other concepts, aspects, features, characteristics, disclosed herein.

User computer 510 is shown in communication with signing computer 530 via a network 560 (e.g., for verifying one or more signatures, such as a signature of a verification public key).

User computer 510 is shown in communication with an advertising computer 565 via a network 570 (e.g., for receiving from advertising computer 565 at user computer 510 one or more advertisements relevant to sensitive data that are determined based on one or more indicators of one or more advertising attributes communicated from user computer 510 to advertising computer 565).

Data generation computer 505 is shown in communication with a data access computer 575 via a network 580 (e.g., for providing one or more elements of sensitive data, such as sensitive data that is too large for inclusion in an optical barcode, to data access computer 575 for further provision to user computer 510 via a network 585). Alternatively or in addition to having one or more elements of additional sensitive data communicated from a data generation computer, such as computer 505, to a data access computer, such as data access computer 575, a data access computer may have one or more additional elements of sensitive data for providing to a user computer (e.g., as discussed above with respect to FIG. 1).

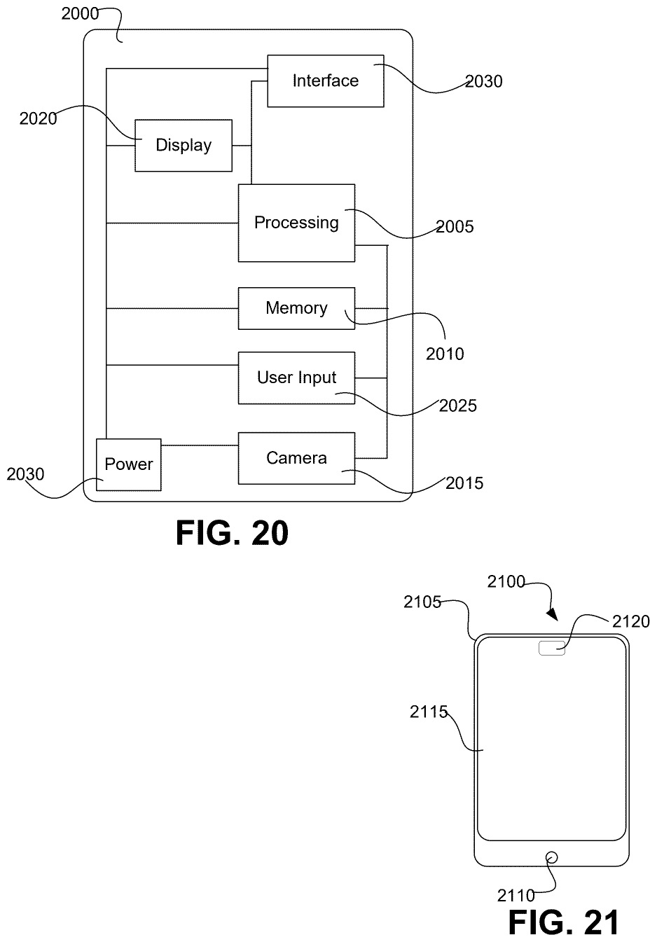

Depending on the particular method of the current disclosure or example execution thereof being performed, one or more of computing devices 505, 510, 530, 565, and 575 may be omitted, as will be clear to those of ordinary skill. Each of computing devices 505, 510, 530, 565, and 575 may include one or more computing devices. Networks 535, 560, 570, 580, 585 are shown as separate networks. It is contemplated that any two or more of networks 535, 560, 570, 580, 585 may be the same network. It is also contemplated that any of networks 535, 560, 570, 580, 585 may include multiple networks therewithin. It is also noted that computing devices 505, 530, 565, and 575 are shown as being separate distributed computing devices. It is contemplated that as with other systems and methods described in the current disclosure, one or more of the functionalities of one of computing devices (e.g., computing devices 505, 530, 565, and 575) may be performed by another of computing devices (e.g., computing devices 505, 530, 565, and 575) and/or one or more of the functionalities of one of computing devices (e.g., one of computing devices 505, 530, 565, and 575) may be performed by multiple computing devices. For example, functionalities of a signing computer, such as signing computer 530, and/or functionalities of an advertising computer, such as advertising computer 565, may be done as part of data generation computer 505. Examples of computing devices and networks are discussed further below (e.g., with respect to FIGS. 20, 21, and 22).

FIG. 6 illustrates one exemplary implementation of a method 600 for managing validation keys (e.g., a public validation key, a private validation key) for use in a method and/or system of providing data of the current disclosure (e.g., method 100, 400, 800, 700, 900, 1000, 1100, 1200). It is noted that the terms “public validation key” and “validation public key” are used interchangeably herein. It is also noted that the terms “private validation key” and “validation private key” may be used interchangeably herein. For the sake of brevity, some of the details, concepts, aspects, features, characteristics, examples, and/or alternatives discussed with respect to the discussion of other implementations in this disclosure are not repeated in the discussion of FIG. 6. Any one or more of the like details, concepts, aspects, features, characteristics, examples, and alternatives from the same may apply similarly here where appropriate, except where noted, as if they were explicitly repeated here.

At step 605, a validation key pair that includes a private validation key and a public validation key are obtained or created. For example, a data generation computer may obtain a validation key pair from a different computer. In another example, a data generation computer generates a validation key pair. As discussed elsewhere herein, a private validation key may be used to sign sensitive data (e.g., at a data generation computer). A public validation key has multiple purposes as disclosed herein (e.g., for use in validating sensitive data at a user computer).

At step 610, the public validation key of the validation key pair is digitally signed with a signing/root key. In one example, a public validation key is communicated from a data generation computer to a signing computer to be digitally signed with a signing/root key (e.g., a private signing root key) with the signing computer returning a signature for the public validation key to the data generation computer. In another example, a public validation key is digitally signed (e.g., with a private signing/root key, such as one obtained from a signing computer) locally at a data generation computer.

At step 615, the validation key pair (and the signature for the public validation key) are stored (e.g., at a data generation computer). In one example, a private validation key may be used to digitally sign a sensitive data (e.g., unencrypted sensitive data) at a data generation computer. In another example, a public validation key and a signature for a public validation key may be included as part of decoding information included in an optical barcode.

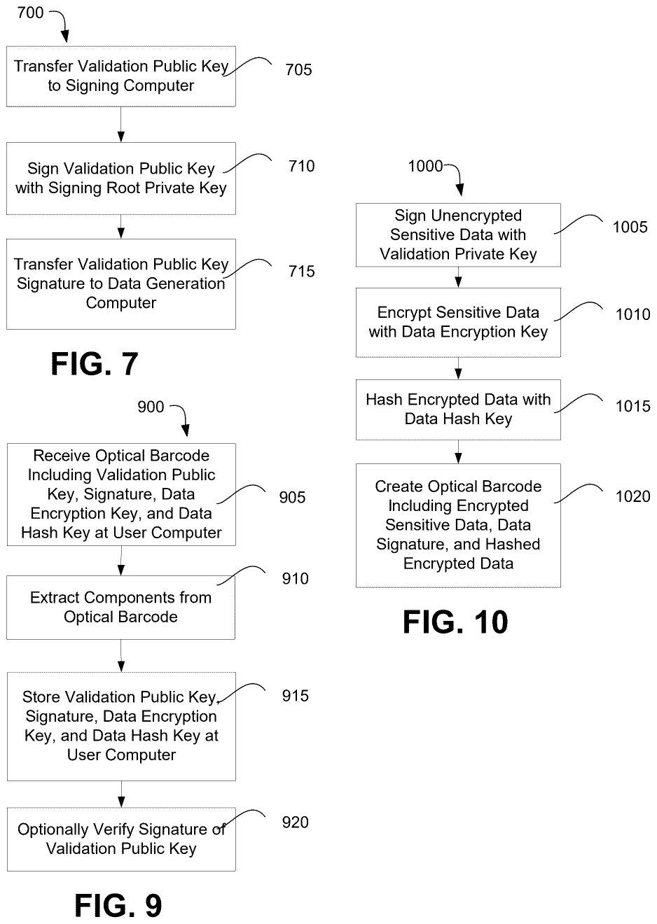

FIG. 7 illustrates another exemplary implementation of a method 700 for managing validation keys for use in a method and/or system of providing data of the current disclosure (e.g., method 100, 400, 800, 700, 900, 1000, 1100, 1200). For the sake of brevity, some of the details, concepts, aspects, features, characteristics, examples, and/or alternatives discussed with respect to the discussion of other implementations in this disclosure are not repeated in the discussion of FIG. 7. Any one or more of the like details, concepts, aspects, features, characteristics, examples, and alternatives from the same may apply similarly here where appropriate, except where noted, as if they were explicitly repeated here.

At step 705, a validation public key is communicated from a data generation computer (e.g., where the validation public key was generated) to a signing computer. At step 710, the validation public key is digitally signed with a signing/root private key at the signing computer. At step 715, the signature for the validation public key is communicated to and received by the data generation computer.

FIG. 8 illustrates one exemplary implementation of a method 800 for creating an optical barcode including decoding information. Such an optical barcode may be utilized in a method and/or system of providing data of the current disclosure (e.g., method 100, 400, 900, 1100, 1200). For the sake of brevity, some of the details, concepts, aspects, features, characteristics, examples, and/or alternatives discussed with respect to the discussion of other implementations in this disclosure are not repeated in the discussion of FIG. 8. Any one or more of the like details, concepts, aspects, features, characteristics, examples, and alternatives from the same may apply similarly here where appropriate, except where noted, as if they were explicitly repeated here.

At step 805, a validation public key is obtained or created at a data generation computer. At step 810 a data encryption key is obtained or created at the data generation computer. At step 815 a data hash key is obtained or created at the data generation computer. At step 820 a signature for the validation public key is obtained or created (e.g., see discussions above for discussion regarding signatures for a validation public key). At step 825, an optical barcode that includes the validation public key, the signature for the validation public key, the data encryption key, and the data hash key is created at the data generation computer (e.g., using a formatting that places the components in a format of the particular optical barcode).

FIG. 9 illustrates one exemplary implementation of a method 900 for processing an optical barcode that includes decoding information at a user computer. Such a method may be utilized as part of another method and/or system for providing data of the current disclosure (e.g., method 100, 400, 900, 1100, 1200). For the sake of brevity, some of the details, concepts, aspects, features, characteristics, examples, and/or alternatives discussed with respect to the discussion of other implementations in this disclosure are not repeated in the discussion of FIG. 9. Any one or more of the like details, concepts, aspects, features, characteristics, examples, and alternatives from the same may apply similarly here where appropriate, except where noted, as if they were explicitly repeated here.

At step 905, an optical barcode that includes a validation public key, a signature for the validation public key, a data encryption key and a data hash key is received at a user computer. At step 910 the validation public key, signature for the validation public key, data encryption key and data hash key are extracted from the optical barcode format. At step 915, the validation public key, signature for the validation public key, data encryption key and data hash key are stored at the user computer (e.g., in a memory associated with the user computer). At step 920, optionally, the signature of the validation public key is verified (e.g., by a process as discussed elsewhere herein, such as with respect to method 100 above).

FIG. 10 illustrates one exemplary implementation of a method 1000 for creating an optical barcode including sensitive data. Such an optical barcode may be utilized in a method and/or system of providing data of the current disclosure (e.g., method 100, 400, 900, 1100, 1200). For the sake of brevity, some of the details, concepts, aspects, features, characteristics, examples, and/or alternatives discussed with respect to the discussion of other implementations in this disclosure are not repeated in the discussion of FIG. 10. Any one or more of the like details, concepts, aspects, features, characteristics, examples, and alternatives from the same may apply similarly here where appropriate, except where noted, as if they were explicitly repeated here.

At step 1005, an unencrypted sensitive data at a data generation computer is digitally signed using a validation private key (e.g., a validation private key corresponding to a validation public key that is made a part of an optical barcode including decoding information, such as in method 800). At step 1010, the sensitive data is encrypted using a data encryption key (e.g., an encryption key that is made a part of an optical barcode including decoding information, such as in method 800). At step 1015, the encrypted sensitive data from step 1010 is hashed using a hash key (e.g., a hash key that is made a part of an optical barcode including decoding information, such as in method 800). At step 1020 an optical barcode is created that includes the encrypted sensitive data, the signature for the sensitive data, and the hashed encrypted data (e.g., using a formatting that places the components in a format of the particular optical barcode). It is noted that an optical barcode including sensitive data, such as that created at step 1020, may also include one or more identifiers that allow a user computer that receives the optical barcode to be able to identify which keys (e.g., which public validation key, which encryption key, which hash key, etc. received in another optical barcode are to be used in association with the corresponding coded sensitive data included in the optical barcode, such as that in step 1020).

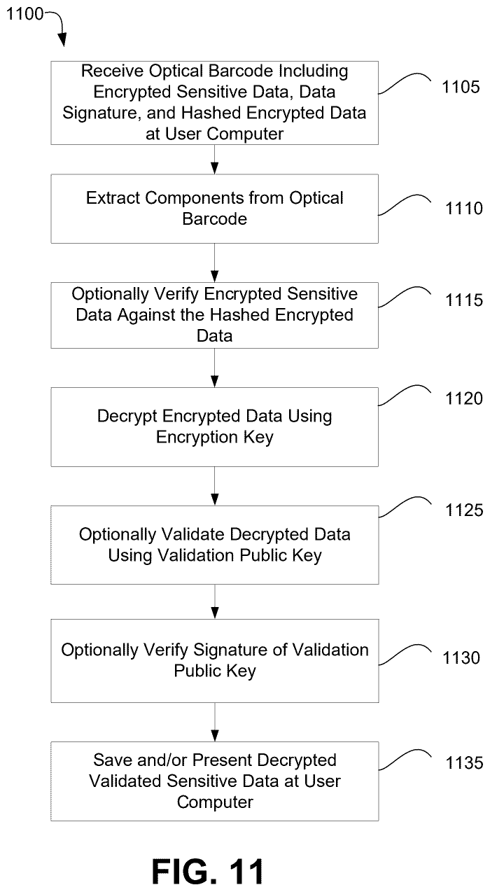

FIG. 11 illustrates still another exemplary implementation of a method (1100) of delivering or otherwise providing sensitive data to an end user. For the sake of brevity, some of the details, concepts, aspects, features, characteristics, examples, and/or alternatives discussed with respect to the discussion of other implementations in this disclosure are not repeated in the discussion of FIG. 11. Any one or more of the like details, concepts, aspects, features, characteristics, examples, and alternatives from the same may apply similarly here where appropriate, except where noted, as if they were explicitly repeated here.

At step 1105, an optical barcode including an encrypted sensitive data, a signature for the sensitive data, and a hashed version of the encrypted data (e.g., an optical barcode created at step 1020 in step 1000) is received at a user computer (e.g., a user computer that also receives an optical barcode including sensitive data such as an optical barcode according to method 800). At step 1110, the encrypted sensitive data, signature for the sensitive data, and hashed version of the encrypted data are extracted from the optical barcode. At step 1115, optionally the encrypted sensitive data is verified against the hashed encrypted data at the user computer. At step 1120, the encrypted data is decrypted using an encryption key (e.g., an encryption key received at the user computer as part of decoding information in a separate optical barcode). At step 1125, optionally the decrypted data from step 1120 is validated using a validation public key (e.g., a validation public key received at the user computer as part of decoding information in a separate optical barcode). At step 1130, optionally a signature of the validation public key (e.g., a signature of the validation public key received at the user computer as part of decoding information in a separate optical barcode) is verified. At step 1135, the decrypted sensitive data is saved and/or presented (e.g., via a display device) to a user of the user computer at the user computer.

The following is an exemplary encoding for an example of a public validation key and its digital signature:

output = binary.Append(output, id);
output = binary.Append(output, PublicKey.Curve);
output = binary.Append(output, this.X);
output = binary.Append(output, this.Y);
output = binary.Append(output, this.name);
output = binary.Append(output, this.email);
output = binary.Append(output, this.KeySignedDate);
output = binary.Append(output, this.Expiration);
output = binary.Append(output, this.KeySigned);
output = binary.Append(output, this.signerProvider);

wherein the “output=binary.Append (output, PublicKey.Curve)” represents an identification of the encryption curve used by the key, the “output=binary.Append (output, this.X)” and “output=binary. Append (output, this. Y)” represent the key itself, the “output=binary.Append (output, this.name)” represents the name of the subject of the corresponding sensitive data, the “output=binary. Append (output, this.email)” represents an email address for the subject of the corresponding sensitive data, the “output=binary.Append (output, this. KeySignedDate)” represents the date of digitally signing the validation public key (e.g., that can be used in verifying the key), the “output=binary. Append (output, this.KeySigned)” represents the data of the signature of the signed key, and the “output=binary. Append (output, this.signerProvider)” represents an identification of the provider entity that signed the key (e.g., which can be used in a process of verifying the key).

The following is an exemplary coding for an example of a symmetric (encryption and hashing) key:

output = binary.Append(output, id);
output = binary.Append(output, this.cryptKey);
output = binary.Append(output, this.iv);
output = binary.Append(output, this.hashKey);

wherein the “output=binary.Append (output, this.cryptKey)” represents the data of an encryption key, the “output=binary.Append (output, this.iv)” represents an initialization vector for use with the encryption and/or hash keys, and the “output=binary.Append (output, this.hashKey)” represents the data of a hash key. It is noted that an encryption and/or hash key may be communicated in an optical barcode along with an initialization vector for use with the encryption and/or hash key (e.g., in decrypting data).

The following is an exemplary coding for an example of an encrypted data that may be included in an optical barcode:

output = binary.Append(output, id);
output = binary.Append(output, sk.getId( ));
output = binary.Append(output, sk.hashBytes);
output = binary.Append(output, sk.cryptMS.ToArray( ));

wherein the “output=binary.Append (output, sk.getId( ))” represents an identifier, the “output=binary. Append (output, sk.hashBytes)” represents a hashed version of encrypted data, and the “output=binary. Append (output, sk.cryptMS.ToArray( ))” represents the encrypted data.

The following is an exemplary coding for an example of a digital signature:

output = binary.Append(output, id);
output = binary.Append(output, pk.signedData);
output = binary.Append(output, this.recordList[0].getId( ));
output = binary.Append(output, signatureTime);
output = binary.Append(output, pk.getId( ));

wherein the “output=binary.Append (output, pk.signedData)” represents the signature of the data that is signed, the “output=binary.Append (output, this.recordList[0].getId( ))” represents an identification of the data that is signed, the “output=binary.Append (output, signatureTime)” represents the time of the signing of the data (e.g., in UTC), and the “output=binary.Append (output, pk.getId( ))” represents an identifier for the public root/signing key utilized in signing the data. It is noted that in the four exemplary codings listed above, one or more of the elements points to data bytes for the particular corresponding item (e.g., that are also included in an optical barcode).

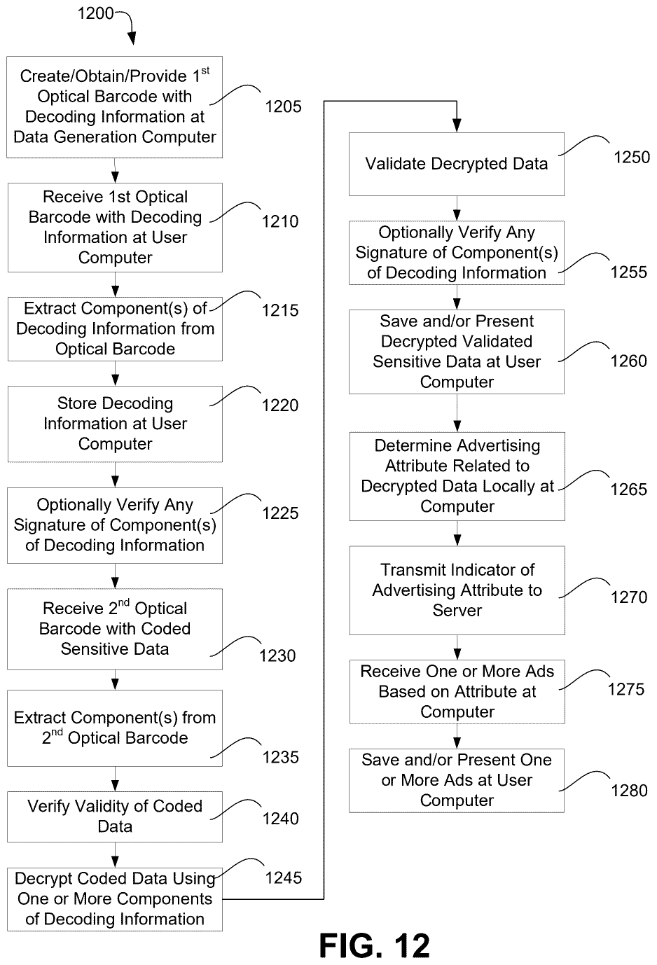

FIG. 12 illustrates still another exemplary implementation of a method (1200) of delivering or otherwise providing sensitive data to an end user. For the sake of brevity, some of the details, concepts, aspects, features, characteristics, examples, and/or alternatives discussed with respect to the discussion of other implementations in this disclosure are not repeated in the discussion of FIG. 12. Any one or more of the like details, concepts, aspects, features, characteristics, examples, and alternatives from the same may apply similarly here where appropriate, except where noted, as if they were explicitly repeated here.

At step 1205, a first optical barcode that includes decoding information is provided (and optionally created and/or obtained) at a data generation computer. At step 1210, the first optical barcode is received at a user computer. At step 1215, components of decoding information are extracted from the format of the optical barcode. At step 1220, the decoding information is stored at the user computer. At step 1225, optionally one or more signatures of a data component (e.g., a signature of a validation public key) if included in the decoding information is verified. At step 1230, a second optical barcode that include coded sensitive data is received at the user computer. At step 1235 components of the coded sensitive data are extracted from the format of the optical barcode at the user computer. At step 1240, the validity of the coded data is verified (e.g., an encrypted sensitive data is verified against a hash of the encrypted sensitive data). At step 1245, the coded sensitive data is decoded using one or more components of the decoding information from step 1220 (e.g., encrypted sensitive data is decrypted using an encryption key of the decoding information). At step 1250, the decrypted sensitive data from step 1220 is validated (e.g., using a public validation key of the decoding information and/or a digital signature of the decrypted sensitive data sent with the coded sensitive data). At step 1255, optionally one or more signatures of a data component (e.g., a signature of a validation public key) if included in the decoding information is verified. At step 1260, the decrypted sensitive data is stored and/or presented (e.g., displayed) to a user of the user computer at the user computer. At step 1265, one or more advertising attributes related to all or a portion of the sensitive data are determined at the user computer. At step 1270, one or more indicators of the one or more advertising attributes is communicated to an advertising computer. At step 1275, one or more advertisements related to the sensitive data is received at the user computer from the advertising computer as determined by the advertising computer based on the one or more indicators in step 1270. At step 1280, the one or more advertisements are saved and/or displayed to a user of the user computer at the user computer.

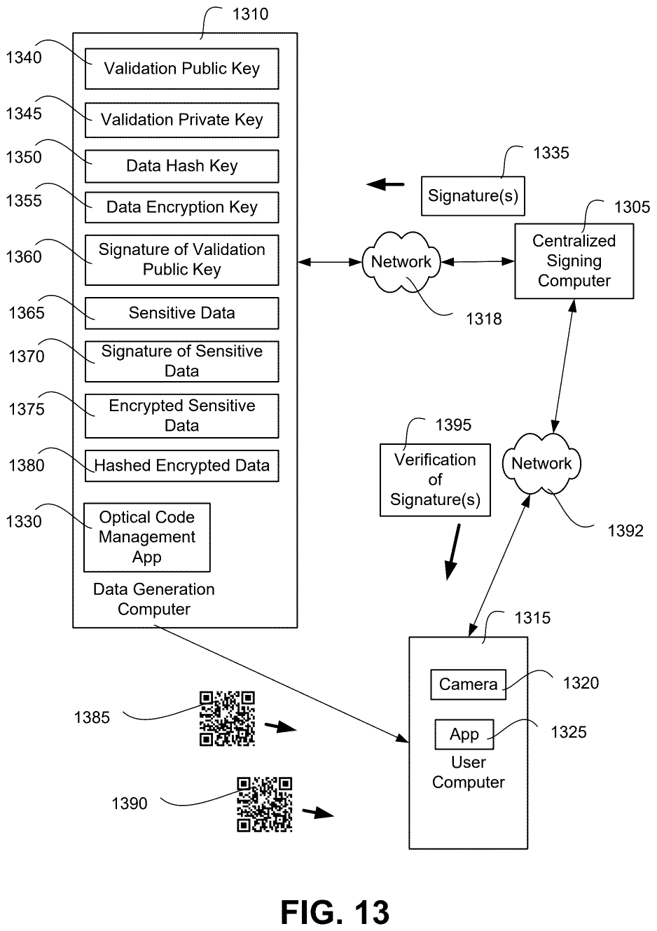

FIG. 13 illustrates one example of an environment of computing devices that can be utilized in a system or method of the current disclosure (e.g., in relation to method 100, 200, 400, 600, 800, 700, 900, 1000, 1100, 1200). For the sake of brevity, some of the details, concepts, aspects, features, characteristics, examples, and/or alternatives discussed with respect to the discussion of other implementations in this disclosure are not repeated in the discussion of FIG. 13. Any one or more of the like details, concepts, aspects, features, characteristics, examples, and alternatives from the same may apply similarly here where appropriate, except where noted, as if they were explicitly repeated here.

FIG. 13 illustrates a signing computer 1305, a data generation computer 1310, and a user computer 1315. User computer 1315 includes a camera/image capture device 1320 (e.g., for receiving one or more optical barcodes) and application programming 1325 (e.g., in the form of executable instructions, such as a software application or “app”) that is configured to perform one or more of the concepts, aspects, features, characteristics of method 100, 200, 400, 600, 800, 700, 900, 1000, 1100, and/or 1200, and/or other concepts, aspects, features, characteristics, disclosed herein, particularly those implemented at or by a user computer. Data generation computer 1310 includes an optical code management application programming 1330 (e.g., in the form of executable instructions, such as a software application or “app”) that is configured to perform one or more of the concepts, aspects, features, characteristics of method 100, 200, 400, 600, 800, 700, 900, 1000, 1100, and/or 1200, and/or other concepts, aspects, features, characteristics, disclosed herein, particularly those implemented at or by a data generation computer. As discussed elsewhere herein, a signing computer (e.g., signing computer 1305) may provide one or more digital signatures of a data object (e.g., a public validation key) provided to it by a data generation computer (e.g., data generation computer 1310 via a network 1318).

Data generation computer 1310 includes a validation public key 1340, a validation private key 1345, a data hash key 1350, a data encryption key 1355, a signature of a validation public key 1360 (e.g., obtained from signing computer 1305), a sensitive data 1365, a signature of sensitive data 1365 1370, a encrypted version of sensitive data 1365 1375, a hashed version of encrypted sensitive data 1365 1380 for use in providing a first optical barcode 1385 including decoding information and a second optical barcode 1390 including coded sensitive data using app 1330. User computer 1315 receives optical barcodes 1385 and 1390.

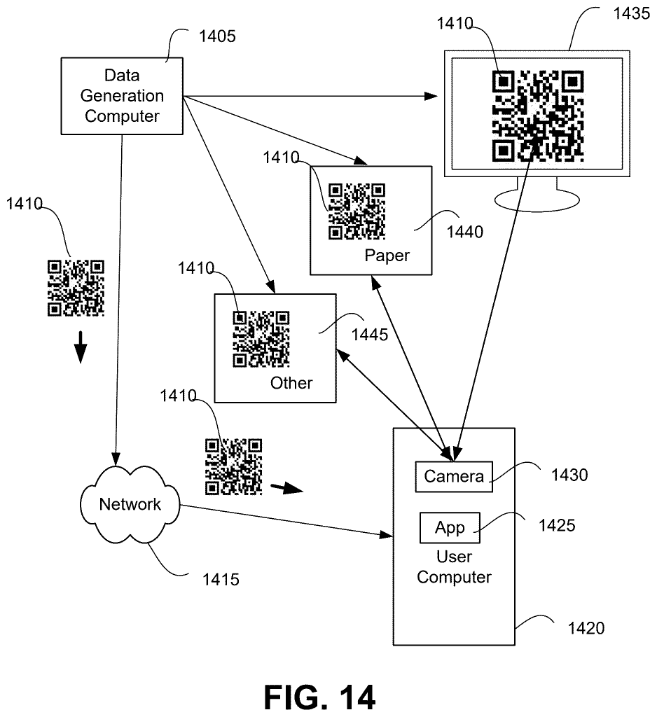

FIG. 14 illustrates one example of an implementation of an environment of providing one or more optical barcodes 1410 from a data generation computer 1405 to a user computer 1420. For the sake of brevity, some of the details, concepts, aspects, features, characteristics, examples, and/or alternatives discussed with respect to the discussion of other implementations in this disclosure are not repeated in the discussion of FIG. 14. Any one or more of the like details, concepts, aspects, features, characteristics, examples, and alternatives from the same may apply similarly here where appropriate, except where noted, as if they were explicitly repeated here.

One or more optical barcodes 1410 may be provided to be received by user computer 1420 in one or more of a variety of ways. User computer 1420 includes application programming 1425 (e.g., in the form of executable instructions, such as a software application or “app”) that is configured to perform one or more of the concepts, aspects, features, characteristics of method 100, 200, 400, 600, 800, 700, 900, 1000, 1100, and/or 1200, and/or other concepts, aspects, features, characteristics, disclosed herein, particularly those implemented at or by a user computer and more particularly those related to receiving an optical barcode. User computer 1420 also includes a camera/image capture device 1430 for receiving optically one or more optical barcodes 1410 (e.g., via a display device 1435, via a printed paper or other material format 1440, via another approach of providing an optical barcode to an imaging device of a computer 1445. One or more optical barcodes 1410 are also shown being provided to be received by user computer 1420 via a network 1415 (e.g., as part of a data transfer, as part of an electronic message, etc.). Not shown, one or more optical barcodes 1410 may also be received by user computer 1410 via a microphone (e.g., during a provision of the optical barcode in an audio transfer technique).

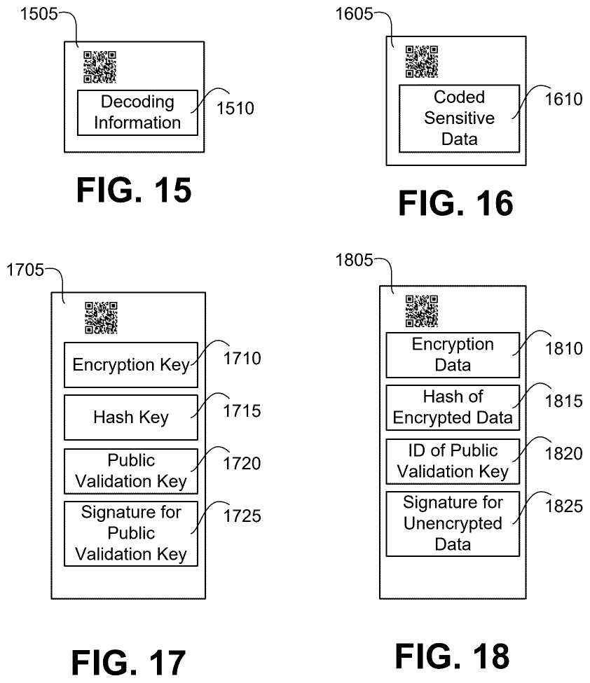

FIG. 15 illustrates one example of a diagrammatic representation of an exemplary optical barcode 1505 that includes a decoding information 1510. FIG. 16 illustrates one example of a diagrammatic representation of an exemplary optical barcode 1605 that includes a coded sensitive data 1610. FIG. 17 illustrates one example of a diagrammatic representation of another exemplary optical barcode 1705 that includes a decoding information that includes an encryption key 1710, a hash key 1715, a public validation key 1720, and a signature of the public validation key 1725. FIG. 18 illustrates one example of another diagrammatic representation of an exemplary optical barcode 1805 that includes a coded sensitive data including an encrypted version of sensitive data 1810, a hash of the encrypted sensitive data 1815, an id of a public validation key associated with the encrypted data 1820, and a signature for the unencrypted sensitive data that created the encrypted data 1825.

In one aspect, one or more embodiments of a SDT platform and associated methods according to the current disclosure may be implemented across a plurality of computing devices, for example over one or more networks. In one such example, components of a platform are located on one or more centralized computer devices (e.g., a cloud resource) and users of the platform access the one or more centralized computer devices via one or more networks. Such access may be by any well-known mechanisms. Examples of such mechanisms include, but are not limited to, Internet connectivity using a web-based application user interface (e.g., using an Internet browsing application on a user device), application software running on a user device that connects to the platform over a network, other known distributed and centralized systems, and any combinations thereof. In one example, machine-executable instructions exist on one or more centralized computer devices and each user of the platform utilizes a local application program or a web-based interface to connect to the one or more centralized computer devices. In one such example, a user can download a user application program that is a part of the platform from a mobile operating system application store (e.g., an Apple iOS store, an Android application store, etc.), from one of the one or more centralized computer devices of the platform, or from another downloadable resource center to be used a user computer for implementing one or more of the aspects of the current disclosure. One example of a user application program may include machine executable instructions stored in the user computing device that interacts with operating system components and hardware components of the user computing device to communicate over a network to the centralized portions of an SDT platform of the current disclosure and to execute such instructions to provide one or more user interfaces of the SDT platform to the user and execute portions of one or more of the aspects of an SDT platform and related methods as disclosed herein.

In one exemplary aspect, a SDT platform of the current disclosure includes one or more user interfaces that display images and/or graphic elements to a user (e.g., via a display device associated with a user computing device) and allow a user to interact with the SDT platform.

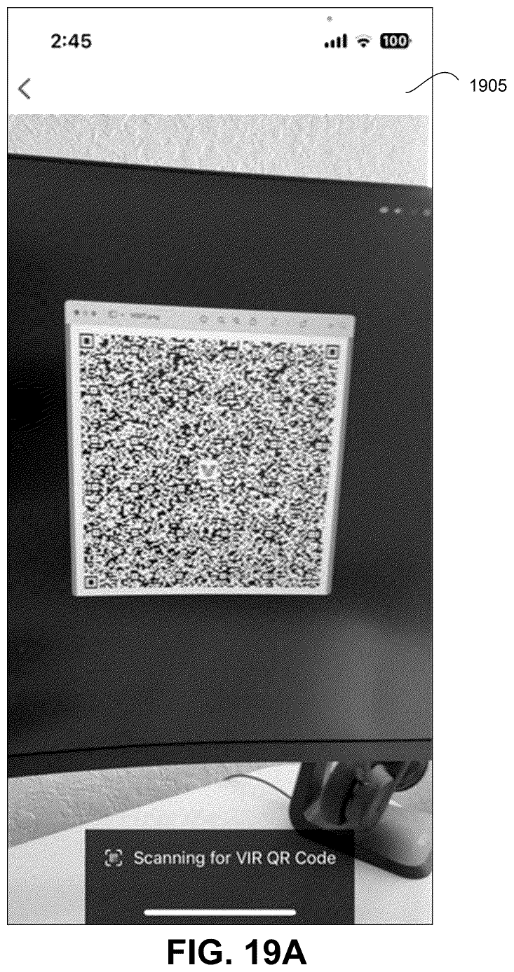

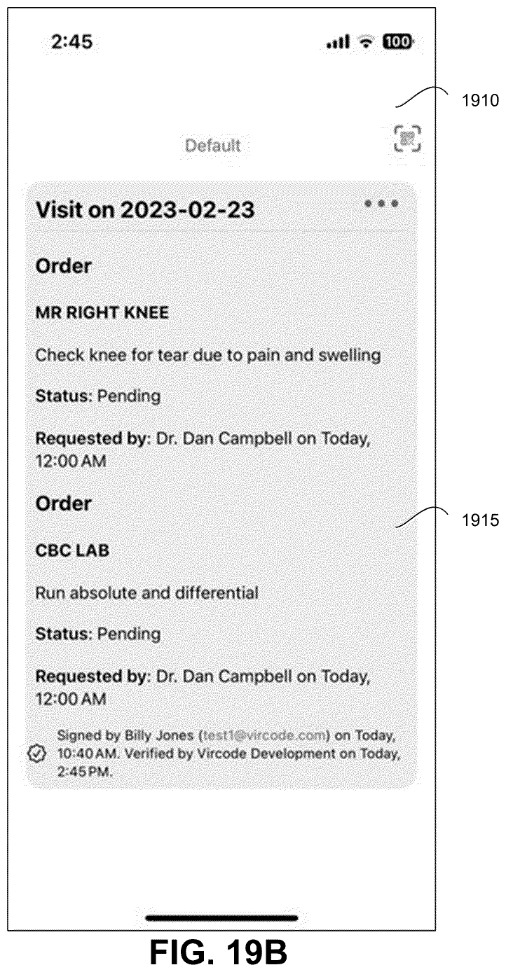

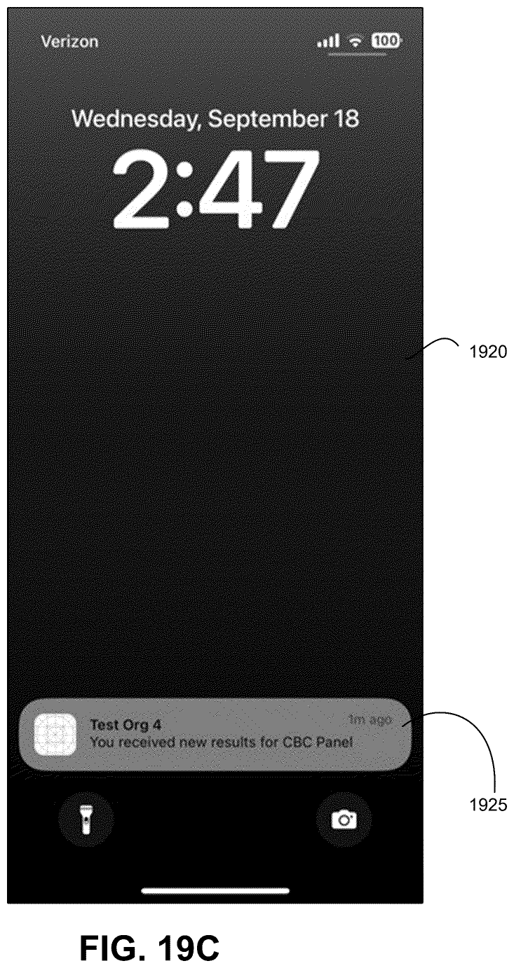

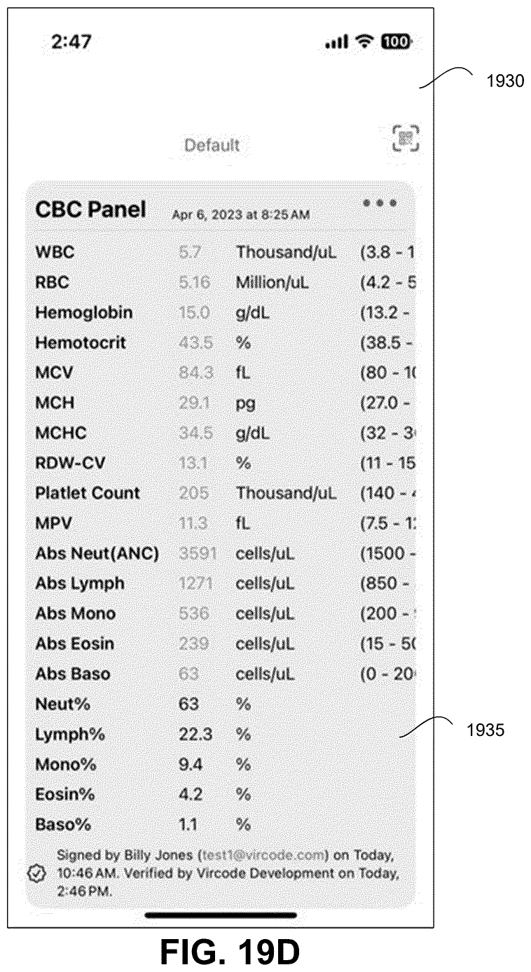

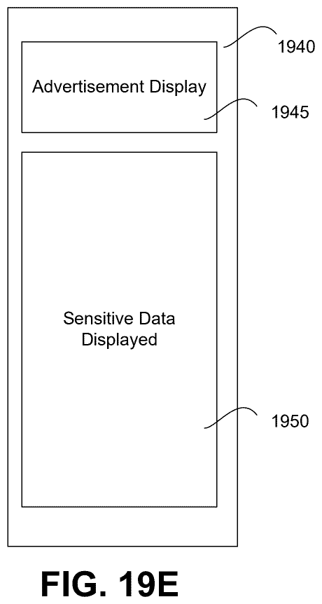

FIGS. 19A to 19E illustrate various exemplary user interfaces that may be used as part of one or more methods and/or systems of the current disclosure. FIG. 19A shows a user interface 1905 that includes a display of a camera/image capture device output (e.g., an output showing an optical barcode in the form of a QR code that is captured by a camera/image capture device of a user computer on which the user interface 1905 is displayed). Such a user interface may be associated with the receiving of an optical barcode (e.g., an optical barcode including decoding information, an optical barcode including coded sensitive data) at a user computer. FIG. 19B shows a user interface 1910 that includes a display of decoded sensitive data 1915 in the form of patient healthcare data that was received at the user computer on which it is displayed as part of an optical barcode (e.g., the optical barcode from user interface 1905) and decoded using decoding information received at the user computer as part of a different optical barcode. FIG. 19C shows a user interface 1920 that includes a display of a computing device lock screen showing date and time information and a push notification 1925 (e.g., a push notification received at the user computer device after registering for push notifications of one or more additional sensitive data that may become available). FIG. 19D shows a user interface 1930 that includes a display of decoded sensitive data in the form of patient healthcare data (e.g., sensitive data decoded at the user computer using decoding information obtained in a separate optical barcode, sensitive data directly downloaded from a location identified by the push notification 1925, a sensitive data automatically downloaded by the user computer based on push notification 1925, a sensitive data received at the user computer as part of an optical barcode, and any combinations thereof. FIG. 19E shows a user interface 1940 including a display of an advertisement 1945 (e.g., an advertisement received from an advertising computer in response to a user computer sending one or more indicators of one or more advertising attributes determine as related to a sensitive data) and a display of a sensitive data 1950 (e.g., a sensitive data relate to the advertisement 1945, a sensitive data unrelated to the advertisement 1945).

It is to be noted that any one or more of the aspects, ideas, concepts, implementations, examples, and embodiments described herein may be conveniently implemented using one or more machines (referred to herein as a computing device, e.g., one or more user computing devices, one or more server devices) programmed according to the teachings of the present disclosure, as will be apparent to those of ordinary skill in the computer art. Appropriate software coding can readily be prepared by skilled programmers based on the teachings of the present disclosure, as will be apparent to those of ordinary skill in the software and related platform arts. Aspects, ideas, concepts, implementations, examples, and embodiments discussed herein may employ software and/or software modules and may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein, except that a machine-readable storage medium is not a medium that simply transports data from one point to another without a time period (however short or long) of storage in a hardware material (e.g., a signal is not a machine-readable storage medium). Examples of a machine-readable storage medium include, but are not limited to, a solid state memory, a flash memory, a random access memory (e.g., a static RAM “SRAM”, a dynamic RAM “DRAM”, etc.), a magnetic memory (e.g., a hard disk, a tape, a floppy disk, etc.), an optical memory (e.g., a compact disc (CD), a digital video disc (DVD), a Blu-ray disc (BD); a readable, writeable, and/or re-writable disc, etc.), a read only memory (ROM), a programmable read-only memory (PROM), a field programmable read-only memory (FPROM), a one-time programmable non-volatile memory (OTP NVM), an erasable programmable read-only memory (EPROM), an electrically erasable programmable read-only memory (EEPROM), and any combinations thereof, and any combinations thereof. Such examples are hardware storage media. If used herein, the term “non-transitory” in relation to a medium refers to a hardware storage medium that stores machine-readable instructions for a period of time, even if that time period is extremely small or temporary, and even if the storage of such instructions is fragile or reliant upon the provision of a continued electrical source. The examples of a machine-readable storage medium listed above in this paragraph are considered non-transitory. For example, machine executable instructions for a SDT platform (or a portion of a SDT platform) and/or related aspects and/or related methods and/or data may, in addition to one or more other machine-readable storage media, be stored in a RAM memory of a computing device (e.g., in RAM memory of a user computing device while a user accesses the digital platform, in RAM memory of a cloud computing device while the platform is being accessed and/or operating, in combination of memory locations in a distributed network environment, etc.) for short periods of time and/or only while the computing device is powered on. In such a case, the RAM memory may be referred to, for example, as a non-transitory medium, A machine-readable medium, as used herein, is intended to include a single medium as well as a collection of physically separate media (localized and/or dispersed physically as in a distributed digital platform having a portion of machine-executable instructions on one or more server computers and/or one or more user devices), such as, for example, a collection of compact disks, one or more hard disk drives in combination with a computer memory, an array of RAM modules, etc. When used herein, the term “memory” includes examples that would include one or more machine-readable storage media. As used herein, the term “machine-readable storage medium” does not include a signal, carrier wave, or similar non-hardware based forms of encoding data, by themselves such forms being transitory in nature.

Such software may also include information (e.g., data, instructions, etc.) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein. Such examples are not to be considered a machine-readable storage medium as that term is used herein. However, it is contemplated that such examples may be used in implementing one or more aspects, ideas, concepts, implementations, examples, and embodiments of the current disclosure if appropriate.

Machine-executable instructions may be disbursed across a plurality of computing devices (e.g., one or more user devices and one or more server computers) and connected via one or more networks.

A computing device is any machine that is capable of executing machine-executable instructions to perform one or more tasks. Examples of a computing device include, but are not limited to, a tablet, an electronic book reading device, a workstation computer, a terminal computer, a server computer, a laptop computer, a mobile telephone (e.g., a smartphone), a portable and/or handheld computing device, a wearable computing device (e.g., a smart watch, a smart wearable eyeglass, a smart wearable headset, an augmented reality wearable device, etc.), a web appliance, a network router, a network switch, a network bridge, one or more application specific integrated circuits, an application specific programmable logic device, an application specific field programmable gate array, any machine capable of executing a sequence of instructions that specify an action to be taken by that machine (e.g., an optical, chemical, biological, quantum and/or nanoengineered system and/or mechanism), and any combinations thereof. In one example, a computing device may include and/or be included in, a kiosk. In another example, a computing device is a smartphone. A computing device may include and/or be programed with specific machine-executable instructions (e.g., to perform one or more of the features, aspects, examples, or implementation of the current disclosure; to operate the computing device generally) and include required circuitry and components such that the combination of the circuitry/components and the instructions allow it to perform as a specialized machine in one or more of the implementations disclosed in the current disclosure. For example, a computing device may utilize any of a variety of known or yet to be developed operating systems, firmware, and/or other software for its operation. Examples of an operating system include, but are not limited to, Apple's iOS, Amazon's Fire OS, Google's Android operating system, Microsoft's Windows Phone operating system, Microsoft's Windows operating system, Apple's Operating System, a Linux-kernel based operating system, and any combinations thereof.

A network is a way for connecting two or more computing devices to each other for communicating information (e.g., data, machine-executable instructions, image files, video files, electronic messages, etc.). Examples of a network include, but are not limited to, a wide area network (e.g., the Internet, an enterprise network), a local area network (e.g., a network associated with an office, a building, a campus or other relatively small geographic space), a short distance network connection, a telephone network, a data network associated with a telephone/voice provider (e.g., a mobile communications provider data and/or voice network), another data network, a direct connection between two computing devices (e.g., a peer-to-peer connection), a proprietary service-provider network (e.g., a cable provider network), a wired connection, a wireless connection (e.g., a Bluetooth connection, a Wireless Fidelity (Wi-Fi) connection (such as an IEEE 802.11 connection), a Worldwide Interoperability for Microwave Access connection (WiMAX) (such as an IEEE 802.16 connection), a Global System for Mobile Communications connection (GSM), a Personal Communications Service (PCS) connection, a Code Division Multiplex Access connection (CDMA), and any combinations thereof. A network may employ one or more wired, one or more wireless, and/or one or more other modes of communication. A network may include any number of network segment types and/or network segments. In one example, a network connection between two computing devices may include a Wi-Fi connection between a sending computing device and a local router, an Internet Service Provider (ISP) owned network connecting the local router to the Internet, an Internet network (e.g., itself potentially having multiple network segments) connection connecting to one or more server computing devices and also to a wireless network (e.g., mobile phone) provider of a recipient computing device, and a telephone-service-provider network connecting the Internet to the recipient computing device.

FIG. 20 illustrates one example diagrammatic representation of one implementation of a computing device 2000. Computing device 2000 includes a processing element 2005, a memory 2010, a display generator 2015, a user input 2020, a networking element 2025, and a power supply 2030. Processing element 2005 includes circuitry and/or machine-executable instructions (e.g., in the form of firmware stored within a memory element included with and/or associated with processing element 2005) for executing instructions for completing one or more tasks (e.g., tasks associated with one or more of the implementations, methodologies, features, aspects, and/or examples described herein). Examples of a processing element include, but are not limited to, a microprocessor, a microcontroller, one or more circuit elements capable of executing a machine-executable instruction, and any combinations thereof.

Memory 2010 may be any device capable of storing data (e.g., user data as part of or affiliated with a SDT platform or other digital platform, information input by a user, information stored by a user, information received at computing device 2000 as part of a SDT or other digital platform, etc.), machine-executable instructions, an operating system, an “app” as part of a SDT or other digital platform, a basic input/output system (BIOS) including basic routines that help to transfer information between components of a computing device, and/or other information related to one or more of the implementations, methodologies, features, aspects, and/or examples described herein. A memory, such as memory 2010, may include one or more machine-readable storage medium.

A memory may be removable from device 2000. A memory, such as memory 2010, may include and/or be associated with a memory access device. For example, a memory may include a medium for storage and an access device including one or more circuitry and/or other components for reading from and/or writing to the medium. In one such example, a computing device may include a port (e.g., a Universal Serial Bus (USB) port) for accepting a memory component (e.g., a removable flash USB memory device).

Device 2000 includes camera 2015 connected to processing element 2005 (and other components). Examples of a camera include, but are not limited to, a still image camera, a video camera, and any combinations thereof.

Display component 2020 is connected to processing element 2005 for providing a display according to any one or more of the implementations, examples, aspects, etc. of the current disclosure (e.g., providing an interface, displaying separated display screens for each of a plurality of portions of an image, etc.). A display component 2015 may include a display element, a driver circuitry, display adapter, a display generator, machine-executable instructions stored in a memory for execution by a processing element for displaying still and/or moving images on a screen, and/or other circuitry for generating one or more displayable images for display via a display element. Example display elements are discussed below. In one example, a display element is integrated with device 2000 (e.g., a built-in LCD touch screen). In another example, a display element is associated with device 2000 in a different fashion (e.g., an external LCD panel connected via a display adapter of display component 2015, a wearable headset having one or more display panels wirelessly connected to device 2000).

User input 2025 is configured to allow a user to input one or more commands, instructions, and/or other information to computing device 2000. For example, user input 2025 is connected to processing element 2005 (and optionally to other components directly or indirectly via processing element 2005) to allow a user to interface with computing device 2000 (e.g., to actuate camera 2015, to input instructions, information, or other inputs for performing (or as otherwise needed for) one or more aspects and/or methodologies of the present disclosure). Examples of a user input include, but are not limited to, a keyboard, a keypad, a screen displayable input (e.g., a screen displayable keyboard), a button, a toggle, a microphone (e.g., for receiving audio instructions), a pointing device, a joystick, a gamepad, a cursor control device (e.g., a mouse), a touchpad, an optical scanner, a video/image capture device (e.g., a camera), a touch screen of a display element/component, a pen device (e.g., a pen that interacts with a touch screen and/or a touchpad), a motion and/or image detecting device (e.g., a three dimensional motion detector) for receiving user gesture commands, and any combination thereof. It is noted that camera 2015 and/or a touch screen of a display element of display component 2020 may function also as an input element. It is also contemplated that one or more commands, data, and/or other information may be input to a computing device via a data transfer over a network and/or via a memory device (e.g., a removable memory device). A user input, such as user input 2025, may be connected to computing device 2000 via an external connector (e.g., an interface port).

External interface element 2030 includes circuitry and/or machine-executable instructions (e.g., in the form of firmware stored within a memory element included with and/or associated with interface element 2030) for communicating with one or more additional computing devices and/or connecting an external device to computing device 2000. An external interface element, such as element 2030, may include one or more external ports. In another example, an external interface element includes an antenna element for assisting with wireless communication. Examples of an external interface element include, but are not limited to, a network adapter, a Small Computer System Interface (SCSI), an advanced technology attachment interface (ATA), a serial ATA interface (SATA), an Industry Standard Architecture (ISA) interface, an extended ISA interface, a Peripheral Component Interface (PCI), a Universal Serial Bus (USB), an IEEE 1394 interface (FIREWIRE), and any combinations thereof. A network adapter includes circuitry and/or machine-executable instructions configured to connect a computing device, such as computing device 2000, to a network.

Power supply 2030 is shown connected to other components of computing device 2005 to provide power for operation of each component. Examples of a power supply include, but are not limited to, an internal power supply, an external power supply, a battery, a fuel cell, a connection to an alternating current power supply (e.g., a wall outlet, a power adapter, etc.), a connection to a direct current power supply (e.g., a wall outlet, a power adapter, etc.), and any combinations thereof.

Components of device 2000 (processing element 2005, memory 2010, camera 2015, display component 2020, user input 2025, interface element 2030, power supply 2035) are shown as single components. A computing device may include multiple components of the same type. A function of any one component may be performed by any number of the same components and/or in conjunction with another component. For example, it is contemplated that the functionality of any two or more of processing element 2005, memory 2010, camera 2015, display component 2020, user input 2025, interface element 2030, power supply 2035, and another component of a computing device may be combined in an integrated circuit. In one such example, a processor (e.g., processing element 2005) may include a memory for storing one or more machine executable instructions for performing one or more aspects and/or methodologies of the present disclosure. Functionality of any one or more components may also be distributed across multiple computing devices. Such distribution may be in different geographic locations (e.g., connected via a network). Components of device 2000 are shown as internal components to device 2000. A component of a computing device, such as device 2000, may be associated with the computing device in a way other than by being internally connected.

Components of computing device 2000 are shown connected to other components. Examples of ways to connect components of a computing device include, but are not limited to, a bus, a component connection interface, another type of connection, and/or any combinations thereof. Examples of a bus and/or component connection interface include, but are not limited to, a memory bus, a memory controller, a peripheral bus, a local bus, a parallel bus, a serial bus, a SCSI interface, an ATA interface, an SATA interface, an ISA interface, a PCI interface, a USB interface, a FIREWIRE interface, and any combinations thereof. Various bus architectures are known. Select connections and components in device 2000 are shown. For clarity, other connections and various other well-known components (e.g., an audio speaker, a printer, etc.) have been omitted and may be included in a computing device. Additionally, a computing device may omit in certain implementations one or more of the shown components.

As discussed above, one example of a computing device that may be utilized in one or more of the implementations of a method of the present disclosure is a handheld computing device. FIG. 21 illustrates one example of a portable handheld computing device in the form of a smartphone 2100. Smartphone 2100 includes a body 2105, a microphone input element 2110, a display element 2115, and a speaker output element 2120. Display element 2115 may be a touch screen to provide a user with additional input interface capabilities. A computing device, such as smartphone 2100, may be used in a variety of ways with respect to any of the implementations, embodiments, and/or methodologies described herein. Exemplary ways to utilize smartphone 2100 (or another computing device) include, but are not limited to, receiving an instruction (and/or other input, request, etc.) from a user of a computing device, presenting information or other displayable aspects to a user of a digital platform, and any combinations thereof.

Examples of a display element or component include, but are not limited to, a computer monitor, a liquid crystal display (LCD) display screen, a light emitting diode (LED) display screen, a touch display, a cathode ray tube (CRT), a plasma display, a projection device, a holographic image projection device, and any combinations thereof. A display element may include, be connected with, and/or associated with adjunct elements to assist with the display of still and/or moving images. Examples of an adjunct display elements include, but are not limited to, a display generator (e.g., image/image display circuitry), a display adapter, a display driver, machine-executable instructions stored in a memory for execution by a processing element for displaying still and/or moving images on a screen, and any combinations thereof. Such display devices may be included in any of a variety of known forms including, but not limited to, a display element directly connected to a computing device, a display element connected to a computing device via a wire, a display element wirelessly connected, a display element of a headset device, a display element of a stand-alone device, a display element of an eyeglass device, and any combinations thereof.

In one exemplary aspect, a SDT platform of the current disclosure includes one or more user interfaces that display images, text, and/or graphic elements to a user (e.g., via a display device associated with a user computing device) and allow a user to interact with a SDT platform (e.g., via one or more user inputs, such as a mouse, touch screen, etc.). For example, via one or more user interfaces, one or more users can access and interact with exemplary implementations of a SDT platform, enter one or more settings, make other interactions, and any combinations thereof.

A user may interact with a user interface via actuation of user interface elements and inputting information. Example input elements for interacting with a user include, but are not limited to, a radio button, a toggle switch, a pull-down menu, a text entry field, a hover button, a drag and drop functionality, a pop-up menu, a right-click menu, a screen displayed keyboard (e.g., a touchscreen keyboard), and any combinations thereof. Examples of interactions with a user interface include, but are not limited to, providing instructions to a digital platform, inputting information to a digital platform (e.g., information required for a user setting, information for a request, etc.), actuating a user interface element, making a selection (e.g., selecting an option in a menu), make an association of one object with another object, inputting text, typing (e.g., on an on-screen keyboard), hovering, gesturing (e.g., moving a hand or other object for detection by a motion detection device of a computing device), swiping in a direction of a user interface, and any combinations thereof. Other example user input element actuations and combinations of actuations will be understood and applicable depending on the particular computing device, interface, display element, etc.

A user interface may be presented to a user as multiple screen displays presented at different times to a user (e.g., in succession). Additionally, multiple user interfaces may be provided as a combined interface (e.g., such that the combined interface displays combined functionality at the same time to a user). Examples of ways to combine functionality in a screen display interface include, but are not limited to, using different portions of a screen display of an interface for different functionality, superimposing a user actuatable element of a screen display over another element of a screen display (e.g., superimposing user actuatable elements for performing one or more functions over an interaction object or subcomponent thereof), and any combinations thereof. Examples of a user actuatable element include but are not limited to, a graphical element, a textual element, an image element, an element selectable using a pointer device, an element selectable using a touch screen actuation, and any combinations thereof.

A user of a digital platform, such as a SDT platform, may utilize one or more user interfaces of the platform to input, make a selection, provide, be presented to, otherwise provide information and/or otherwise interact with the platform (and/or other users) as required by any one or more of the details, concepts, aspects, features, characteristics, examples, and/or alternatives of an implementation, embodiment, method, and/or other methodology disclosed herein.

A computer device, such as computing device 2000, 2100, 2200 (see below), may include a haptic response generator (e.g., a vibrating functionality). When a user interacts with an element of a user interface (e.g., a virtual object, another user actuatable element, etc.) a digital platform, such as an SDT platform as described herein, may be configured to provide a haptic response to a user (e.g., via a haptic response generator of the user's computing device). In one example, an SDT platform includes a user interface haptic response that vibrates a user's computing device. In another example, an SDT platform includes a user interface haptic response that vibrates a user's computing device when the user selects an item in a user interface (e.g., selects a virtual indicator).

An SDT platform my need to communicate with one or more computing devices or software applications outside of the SDT platform. Such communication may be achieved by known mechanisms or future developed mechanisms. One such mechanism is an Application Programming Interface (“API”). In one example, an SDT platform can communicate via an API of a phone's software to obtain information (e.g., GPS information) for use in the SDT platform. In another example, an SDT platform can communicate via an API of a database to obtain information for use in the SDT platform.

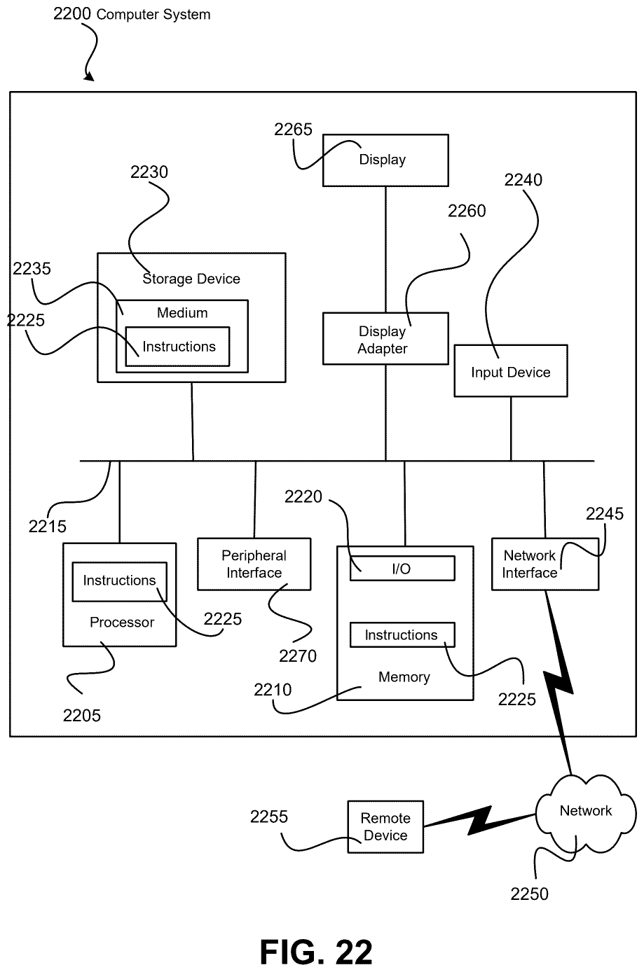

FIG. 22 shows a diagrammatic representation of one embodiment of a computing device in the exemplary form of a computer system 2200 within which a set of instructions for causing the device to perform any one or more of the aspects and/or methodologies of the present disclosure may be executed. It is also contemplated that multiple computing devices may be utilized to implement a specially configured set of instructions for causing the device to perform any one or more of the aspects and/or methodologies of the present disclosure. Any such device or combination of devices constitutes a specially programmed machine for the functionalities of the current disclosure (e.g., an SDT platform or related methods disclosed herein). Computer system 2200 includes a processor 2205 and a memory 2210 that communicate with each other, and with other components, via a bus 2215. Bus 2215 may include any of several types of bus structures including, but not limited to, a memory bus, a memory controller, a peripheral bus, a local bus, and any combinations thereof, using any of a variety of bus architectures.

Memory 2210 may include various components (e.g., machine readable media) including, but not limited to, a random access memory component (e.g., a static RAM “SRAM”, a dynamic RAM “DRAM”, etc.), a read only component, and any combinations thereof. In one example, a basic input/output system 2220 (BIOS), including basic routines that help to transfer information between elements within computer system 2200, such as during start-up, may be stored in memory 2210. Memory 2210 may also include (e.g., stored on one or more machine-readable media) instructions (e.g., software) 2225 embodying any one or more of the aspects and/or methodologies of the present disclosure. In another example, memory 2210 may further include any number of program modules including, but not limited to, an operating system, one or more application programs, other program modules, program data, and any combinations thereof.

Computer system 2200 may also include a storage device 2230. Examples of a storage device (e.g., storage device 2230) include, but are not limited to, a hard disk drive for reading from and/or writing to a hard disk, a magnetic disk drive for reading from and/or writing to a removable magnetic disk, an optical disk drive for reading from and/or writing to an optical media (e.g., a CD, a DVD, etc.), a solid-state memory device, and any combinations thereof. Storage device 2230 may be connected to bus 2215 by an appropriate interface (not shown). Example interfaces include, but are not limited to, SCSI, advanced technology attachment (ATA), serial ATA, universal serial bus (USB), IEEE 2294 (FIREWIRE), and any combinations thereof. In one example, storage device 2230 (or one or more components thereof) may be remotely interfaced with computer system 2200 (e.g., via an external port connector (not shown)). Particularly, storage device 2230 and an associated machine-readable medium 2235 may provide nonvolatile and/or volatile storage of machine-readable instructions, data structures, program modules, and/or other data for computer system 2200. In one example, software 2225 may reside, completely or partially, within machine-readable medium 2235. In another example, software 2225 may reside, completely or partially, within processor 2205.

Computer system 2200 may also include an input device 2240 (e.g., a user input). In one example, a user of computer system 2200 may enter commands and/or other information into computer system 2200 via input device 2240. Input device 2240 may be interfaced to bus 2215 via any of a variety of interfaces (not shown) including, but not limited to, a serial interface, a parallel interface, a game port, a USB interface, a FIREWIRE interface, a direct interface to bus 2215, and any combinations thereof. Input device may include a touch screen interface that may be a part of or separate from display 2265, discussed further below.

A user may also input commands and/or other information to computer system 2200 via storage device 2230 (e.g., a removable disk drive, a flash drive, etc.) and/or a network interface device 2245. A network interface device, such as network interface device 2245 may be utilized for connecting computer system 2200 to one or more of a variety of networks, such as network 2250, and one or more remote devices 2255 connected thereto. Examples of a network interface device include, but are not limited to, a network interface card (e.g., a mobile network interface card, a LAN card), a modem, a wireless transmitter, a wireless receiver, a wireless transceiver, and any combination thereof. Information (e.g., data, software 2225, etc.) may be communicated to and/or from computer system 2200 via network interface device 2245.

Computer system 2200 may further include a video display adapter 2260 for communicating a displayable image to a display device, such as display device 2265 (e.g., for providing user access to one or more user interfaces). In addition to a display device, a computer system 2200 may include one or more other peripheral output devices including, but not limited to, an audio speaker, a printer, and any combinations thereof. Such peripheral output devices may be connected to bus 2215 via a external interface element 2270.

A computer system, such as system 2000, 2100, 2200, may include a positioning device (not shown) to determine the location of the computer system (and, optionally, a user of the computer system). Example positioning devices, such as a GPS (Global Positioning System) device, a GLONASS positioning system device, a Galileo positioning system device, another satellite based positioning device, a radio frequency based positioning system device, a Wi-Fi based positioning system device, a mobile network positioning system device, a local positioning system device, and any combinations thereof. A computer system, such as system 2000, 2100, 2200, may also include an orientation device (not shown) capable of determining an orientation of the computer system in two or more dimensions. Orientation determining devices and related circuitries are well known to those of ordinary skill.

### EXAMPLES

1. A method of delivering sensitive data to a first user's computer, the method comprising:
   receiving a first matrix barcode at a first user computer, the first matrix barcode having embedded therein a first decoding information;
   extracting at the first user computer the first decoding information from the first matrix barcode;
   receiving a second matrix bar code at the first user computer, the second matrix barcode having a first sensitive data;
   extracting at the first user computer the first sensitive data from the second matrix barcode;
   decoding the first sensitive data at the first user computer using the first decoding information;
   determining one or more advertising attributes related to the first sensitive data using only executable programming located locally at the first user computer without transmitting the first sensitive data from the first user computer;
   transmitting from the first user computer the one or more advertising attributes to a centralized server computer; and
   receiving at the first user computer from the centralized server computer one or more advertisements based on the one or more advertising attributes.
2. A method according to example 1, wherein said receiving a first matrix barcode includes scanning the first matrix barcode with an optical capture device of the first user computer.
3. A method according to example 1, wherein said receiving a first matrix barcode includes wirelessly receiving the first matrix barcode at the first user computer.
4. A method according to example 1, wherein the first matrix barcode includes a matrix barcode selected from the group consisting of an ISO/IEC 16022 barcode, an ISO/IEC 18004 barcode, and ISO/IEC 23941 barcode, an Aztec code, a QR code, a SPARQCode, and any combinations thereof.
5. A method according to example 1, wherein the first matrix barcode includes a QR code.
6. A method according to example 1, wherein the first matrix barcode is a QR code.
7. A method according to example 1, wherein the second matrix barcode includes a matrix barcode selected from the group consisting of an ISO/IEC 16022 barcode, an ISO/IEC 18004 barcode, and ISO/IEC 23941 barcode, an Aztec code, a QR code, a SPARQCode, and any combinations thereof.
8. A method according to example 1, wherein the second matrix barcode includes a QR code.
9. A method according to example 1, wherein the second matrix barcode is a QR code.
10. A method according to example 1, wherein the first matrix barcode and the second matrix barcode are each a QR code.
11. A method according to example 1, wherein the first matrix barcode further includes a signing public key.
12. A method according to example 11, further comprising:
   using the signing public key from the first user computer to verify at a centralized computer the authenticity of the first matrix barcode.
13. A method according to example 1, wherein the second matrix barcode further includes a signing public key.
14. A method according to example 11, further comprising:
   using the signing public key from the first user computer to verify at a centralized computer the authenticity of the second matrix barcode.
15. A method according to example 1, further comprising storing the first matrix barcode at the first user computer prior to said receiving a second matrix barcode
16. A method according to example 1, further comprising storing the first decoding information at the first user computer.
17. A method according to example 1, wherein the first sensitive data includes a data selected from the group consisting of a healthcare data, a financial data, a universal resource locator, and any combinations thereof.
18. A method according to example 1, further comprising:
   using a universal resource locator included with the first sensitive data, retrieving from a second remote computer one or more sensitive data files.
19. A method of delivering sensitive data to a first user's computer, the method comprising:
   receiving at a first user computer from a first service provider a first matrix barcode, the first matrix barcode including a first sensitive data;
   decoding at the first user computer the first sensitive data using a first decoding information retrieved from a second matrix barcode received at the first computer prior to the first matrix barcode.
20. A method of delivering sensitive data to a first user's computer, the method comprising:
   receiving a first optical barcode at a first user computer, the first optical barcode having embedded therein a first decoding information;
   extracting at the first user computer the first decoding information from the first optical barcode;
   receiving a second matrix bar code at the first user computer, the second optical barcode having a first sensitive data;
   extracting at the first user computer the first sensitive data from the second optical barcode;
   decoding the first sensitive data at the first user computer using the first decoding information;
   determining one or more advertising attributes related to the first sensitive data using only executable programming located locally at the first user computer without transmitting the first sensitive data from the first user computer;
   transmitting from the first user computer the one or more advertising attributes to a centralized server computer; and
   receiving at the first user computer from the centralized server computer one or more advertisements based on the one or more advertising attributes.
21. A method according to example 20, wherein said receiving a first optical barcode includes scanning the first optical barcode with an optical capture device of the first user computer.
22. A method according to any one of examples 20 to 21, wherein said receiving a first optical barcode includes wirelessly receiving the first optical barcode at the first user computer.
23. A method according to any one of examples 20 to 22, wherein the first optical barcode includes a optical barcode selected from the group consisting of an ISO/IEC 16022 barcode, an ISO/IEC 18004 barcode, and ISO/IEC 23941 barcode, an Aztec code, a QR code, a SPARQCode, and any combinations thereof.
24. A method according to any one of examples 20 to 23, wherein the first optical barcode includes a QR code.
25. A method according to any one of examples 20 to 24, wherein the first optical barcode is a QR code.
26. A method according to any one of examples 20 to 25, wherein the second optical barcode includes a optical barcode selected from the group consisting of an ISO/IEC 16022 barcode, an ISO/IEC 18004 barcode, and ISO/IEC 23941 barcode, an Aztec code, a QR code, a SPARQCode, and any combinations thereof.
27. A method according to any one of examples 20 to 26, wherein the second optical barcode includes a QR code.
28. A method according to any one of examples 20 to 27, wherein the second optical barcode is a QR code.
29. A method according to any one of examples 20 to 28, wherein the first optical barcode and the second optical barcode are each a QR code.
30. A method according to any one of examples 20 to 29, wherein the first optical barcode further includes a signing public key.
31. A method according to example 30, further comprising:
   using the signing public key from the first user computer to verify at a centralized computer the authenticity of the first optical barcode.
32. A method according to any one of examples 20 to 31, wherein the second optical barcode further includes a signing public key.
33. A method according to example 32, further comprising:
   using the signing public key from the first user computer to verify at a centralized computer the authenticity of the second optical barcode.
34. A method according to any one of examples 20 to 33, further comprising storing the first optical barcode at the first user computer prior to said receiving a second optical barcode
35. A method according to any one of examples 20 to 34, further comprising storing the first decoding information at the first user computer.
36. A method according to any one of examples 20 to 35, wherein the first sensitive data includes a data selected from the group consisting of a healthcare data, a financial data, a universal resource locator, and any combinations thereof.
37. A method according to any one of examples 20 to 36, further comprising:
   using a universal resource locator included with the first sensitive data, retrieving from a second remote computer one or more sensitive data files.
38. A method of delivering sensitive data to a first user's computer, the method comprising:
   receiving at a first user computer from a first service provider a first optical barcode, the first optical barcode including a first sensitive data;
   decoding at the first user computer the first sensitive data using a first decoding information retrieved from a second optical barcode received at the first computer prior to the first optical barcode.
39. A system for performing any one of the previous examples.
40. A machine readable storage medium including executable instructions for performing any of the previous method examples, the instructions including sets of instructions for performing each of the method steps.

Some of the details, concepts, aspects, features, characteristics, examples, and/or alternatives of a component/element discussed above with respect to one implementation, embodiment, and/or methodology may be applicable to a like component in another implementation, embodiment, and/or methodology, even though for the sake of brevity it may not have been repeated above. It is noted that any suitable combinations of components and elements of different implementations, embodiments, and/or methodologies (as well as other variations and modifications) are possible in light of the teachings herein, will be apparent to those of ordinary skill, and should be considered as part of the spirit and scope of the present disclosure. Additionally, functionality described with respect to a single component/element is contemplated to be performed by a plurality of like components/elements (e.g., in a more dispersed fashion locally and/or remotely). Functionality described with respect to multiple components/elements may be performed by fewer like or different components/elements (e.g., in a more integrated fashion).

For example, for the sake of brevity, some of the details, concepts, aspects, features, characteristics, examples, and/or alternatives discussed with respect to one implementation and/or embodiment of the current disclosure may not be repeated in a discussion of another implementation and/or embodiment where such details, concepts, aspects, features, characteristics, examples, and/or alternatives may be applicable for like items or in combination with other items discussed with respect to the subsequent figure and, as applicable, may be included in (or otherwise apply similarly with) the implementation of that additional discussion, except where noted or inapplicable/incompatible.

While details, concepts, aspects, features, characteristics, examples, and/or alternatives of various implementations and embodiments herein are described in the context of one or more embodiments of an SDT platform, it is contemplated that any such details, concepts, aspects, features, characteristics, examples, and/or alternatives and corresponding implementations and embodiments may also be utilized with a different embodiment of a SDT platform or other type of online platform, system, or environment as applicable.

If present in a claim or a description herein, the use of ordinal terms (e.g., “first,” “second,” “third,” etc.) to modify another term or phrase, such use is solely as labels to distinguish one item from another item of the same name and should not itself be construed to impart any order, precedence, or priority of one item over another. If any method is presented herein through the use of a flowchart or other flow diagram with a sequential nature, it is noted that it may be possible for one or more of the steps depicted to be performed in a parallel fashion to each other. Additionally, methods presented in a particular order of steps may have their steps performed in a different order than presented as applicable as well as having fewer steps or additional steps involved in the method. As used herein, a “set” of items may include one or more of such items.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. A method of delivering sensitive data to a first user's computer, the method comprising:
receiving a first optical barcode at a first user computer, the first optical barcode having embedded therein a first decoding information;
extracting at the first user computer the first decoding information from the first optical barcode;
receiving a second matrix bar code at the first user computer, the second optical barcode having a first sensitive data;
extracting at the first user computer the first sensitive data from the second optical barcode;
decoding the first sensitive data at the first user computer using the first decoding information;
determining one or more advertising attributes related to the first sensitive data using only executable programming located locally at the first user computer without transmitting the first sensitive data from the first user computer;
transmitting from the first user computer the one or more advertising attributes to a centralized server computer; and
receiving at the first user computer from the centralized server computer one or more advertisements based on the one or more advertising attributes.

2. A method according to claim 1, wherein said receiving a first optical barcode includes scanning the first optical barcode with an optical capture device of the first user computer.

3. A method according to claim 1, wherein said receiving a first optical barcode includes wirelessly receiving the first optical barcode at the first user computer.

4. A method according to claim 1, wherein the first optical barcode includes a optical barcode selected from the group consisting of an ISO/IEC 16022 barcode, an ISO/IEC 18004 barcode, and ISO/IEC 23941 barcode, an Aztec code, a QR code, a SPARQCode, and any combinations thereof.

5. A method according to claim 1, wherein the first optical barcode includes a QR code.

6. A method according to claim 1, wherein the first optical barcode is a QR code.

7. A method according to claim 1, wherein the second optical barcode includes a optical barcode selected from the group consisting of an ISO/IEC 16022 barcode, an ISO/IEC 18004 barcode, and ISO/IEC 23941 barcode, an Aztec code, a QR code, a SPARQCode, and any combinations thereof.

8. A method according to claim 1, wherein the second optical barcode includes a QR code.

9. A method according to claim 1, wherein the second optical barcode is a QR code.

10. A method according to claim 1, wherein the first optical barcode and the second optical barcode are each a QR code.

11. A method according to claim 1, wherein the first optical barcode further includes a signing public key.

12. A method according to claim 11, further comprising:
using the signing public key from the first user computer to verify at a centralized computer the authenticity of the first optical barcode.

13. A method according to claim 1, wherein the second optical barcode further includes a signing public key.

14. A method according to claim 13, further comprising:
using the signing public key from the first user computer to verify at a centralized computer the authenticity of the second optical barcode.

15. A method according to claim 1, further comprising storing the first optical barcode at the first user computer prior to said receiving a second optical barcode.

16. A method according to claim 1, further comprising storing the first decoding information at the first user computer.

17. A method according to claim 1, wherein the first sensitive data includes a data selected from the group consisting of a healthcare data, a financial data, a universal resource locator, and any combinations thereof.

18. A method according to claim 1, further comprising:
using a universal resource locator included with the first sensitive data, retrieving from a second remote computer one or more sensitive data files.

19. A method of delivering sensitive data to a first user's computer, the method comprising:
receiving at a first user computer from a first service provider a first optical barcode, the first optical barcode including a first sensitive data; and
decoding at the first user computer the first sensitive data using a first decoding information retrieved from a second optical barcode received at the first computer prior to the first optical barcode.

20. A machine readable storage medium including executable instructions for performing a method of delivering sensitive data to a first user's computer, the instructions comprising:
a set of instructions for receiving a first optical barcode at a first user computer, the first optical barcode having embedded therein a first decoding information;
a set of instructions for extracting at the first user computer the first decoding information from the first optical barcode;
a set of instructions for receiving a second matrix bar code at the first user computer, the second optical barcode having a first sensitive data;
a set of instructions for extracting at the first user computer the first sensitive data from the second optical barcode;
a set of instructions for decoding the first sensitive data at the first user computer using the first decoding information;
a set of instructions for determining one or more advertising attributes related to the first sensitive data using only executable programming located locally at the first user computer without transmitting the first sensitive data from the first user computer;
a set of instructions for transmitting from the first user computer the one or more advertising attributes to a centralized server computer; and
a set of instructions for receiving at the first user computer from the centralized server computer one or more advertisements based on the one or more advertising attributes.
